(19) United States
(12) Patent Application Publication
(10) Pub. No.: US 2026/0139132 A1
(43) Pub. Date: May 21, 2026

(54) POLYPROPYLENE COMPOSITION FOR CABLE INSULATION

(71) Applicant: BOREALIS AG, Vienna (AT)

(72) Inventors: Katja Klimke, Linz (AT); Jingbo Wang, Linz (AT); Per-Ola Hagstrand, Stenungsund (SE); Ulf Nilsson, Stenungsund (SE); Thomas Gkourmpis, Stenungsund (SE); Lars Efraimsson, Stenungsund (SE); Anette Johansson, Stenungsund (SE); Gerhard Hubner, Linz (AT)

(21) Appl. No.: 19/114,546

(22) PCT Filed: Sep. 26, 2023
(86) PCT No.: PCT/EP2023/076456

§ 371 Date: Mar. 24, 2025

(30) Foreign Application Priority Data
Sep. 28, 2022 (EP) 22198322.4

(51) Int. Cl. C08L 23/14; H01B 3/44

(52) U.S. Cl. CPC C08L 23/142; H01B 3/441; C08L 2203/202; C08L 2207/02

(57) ABSTRACT

The present invention relates to a cable comprising at least one layer comprising a polypropylene composition comprising (A) from 80.0 to 99.0 wt.-%, preferably from 82.5 to 97.2 wt. %, most preferably from 85.0 to 95.0 wt.-% of a copolymer of propylene and comonomer units selected from ethylene and alpha-olefins having from 4 to 12 carbon atoms having a total amount of comonomer units of from 10.0 to 16.0 wt %, preferably from 11.0 to 15.0 wt %, most preferably from 12.0 to 14.0 wt %, based on the total amount of monomer units of the copolymer of propylene (A): a melt flow rate MFR2 of from 0.5 to 5.0 g/10 min. preferably from 0.8 to 4.5 g/10 min. still more preferably from 1.0 to 4.3 g/10 min and most preferably from 1.2 to 4.0 g/10 min; a xylene cold soluble (XCS) fraction in a total amount of from 25.0 to 50.0 wt %, preferably from 27.5 to 45.0 wt %, more preferably from 30.0 to 42.5 wt % and most preferably from 32.5 to 40.0 wt %, based on the total weight amount of the copolymer of propylene (A); and (B) from 1.0 to 20.0 wt.-%, preferably from 2.5 to 17.5 wt %, most preferably from 5.0 to 15.0 wt.-% of a linear block copolymer comprising styrene, monomer units selected from ethylene, propylene and/or I-butene, having a total content of styrene units of from 1.0 to 30.0 wt.-%, preferably from 2.0 to 27.5 wt.-%, most preferably from 3.0 to 25.0 wt.-%, based on the total weight amount of the linear block copolymer (B).

The present invention relates to a cable comprising an insulation layer comprising at least one layer, preferably an insulation layer, which comprises a flexible polypropylene composition.

### TECHNICAL BACKGROUND

Nowadays, ethylene polymer products are used as insulation and semiconducting shields for low, medium and high voltage cables, due to easy processability and their beneficial electrical properties. In addition, in low voltage applications polyvinyl chloride (PVC) is also commonly used as insulation material, usually in combination with softeners to reach desirable softness of cables. PVC is a thermoplastic which by incorporation of various plasticizers can be used in a wide temperature range. For standard PVC a continuous conductor temperature of max. 70° C. is normal. At low temperatures PVC becomes rigid and usage temperatures below −10° C. should be avoided. At conductor temperatures over 100° C. the plasticizers migrate out and the materials lose their flexibility. However, with the addition of special plasticizers and stabilizers, PVC materials can be produced for conductor temperatures of 90-105° C. But in essence, PVC is mainly used for the 1 kV area, as the higher permittivity and dissipation factor of the material means that the losses increase too much at higher voltages and therefore PVC cables are not normally not used over 1 kV. In addition, softeners have to be added to PVC in order to maintain a high level of flexibility. Insufficient amounts of softeners reduce low temperature properties of PVC significantly. From an environmental point of view, these softeners are not always regarded as problem-free, making them desirable to eliminate.

Especially for medium, high and extra high voltage (MV, HV and EHV) cables, as well as high-voltage direct current (HVDC) cables, insulation material presently is dominated by crosslinked ethylene polymer (XLPE) products. These products have a high operation temperature, a high electric breakdown strength and good mechanical properties. However, due to its crosslinking the XLPE is not recyclable by remelting. Therefore, attempts were made to use thermoplastic material and especially thermoplastic propylene polymers as insulation material for medium, high and extra high voltage (MV, HV and EHV) cables as well as high-voltage direct current (HVDC) cables. Further, power network owners are developing an increasing interest for cables that can be recycled by remelting.

Thus, there is an increasing interest in polymer compositions based on thermoplastic propylene polymers for insulation layers of medium voltage (MV), high voltage (HV), extra high voltage (EHV) and high-voltage direct current (HVDC) cables. Thereby, the propylene polymers need to show a good balance of properties as regards e.g. flexibility, mechanical properties, impact properties and electrical breakdown strength.

Thus, there is a need in the art for polypropylene compositions suitable for cable insulation and shows a good balance of properties as regards flexibility, mechanical properties, impact properties and electric breakdown strength, when used as cable insulation for MV or HV cables.

### SUMMARY OF THE INVENTION

The present invention relates to a cable comprising at least one layer comprising a polypropylene composition comprising
(A) from 80.0 to 99.0 wt.-%, preferably from 82.5 to 97.2 wt. %, most preferably from 85.0 to 95.0 wt.-%, based on the total weight of the polypropylene composition, of a copolymer of propylene and comonomer units selected from ethylene and alpha-olefins having from 4 to 12 carbon atoms having
   a total amount of comonomer units of from 10.0 to 16.0 wt %, preferably from 11.0 to 15.0 wt %, most preferably from 12.0 to 14.0 wt %, based on the total amount of monomer units of the copolymer of propylene (A);
   a melt flow rate MFR₂ of from 0.5 to 5.0 g/10 min, preferably from 0.8 to 4.5 g/10 min, still more preferably from 1.0 to 4.3 g/10 min and most preferably from 1.2 to 4.0 g/10 min;
   a xylene cold soluble (XCS) fraction in a total amount of from 25.0 to 50.0 wt %, preferably from 27.5 to 45.0 wt %, more preferably from 30.0 to 42.5 wt % and most preferably from 32.5 to 40.0 wt %, based on the total weight amount of the copolymer of propylene (A); and
(B) from 1.0 to 20.0 wt.-%, preferably from 2.5 to 17.5 wt %, most preferably from 5.0 to 15.0 wt.-%, based on the total weight of the polypropylene composition, of a linear styrene block copolymer with a middle block containing sequences of ethylene, propylene and/or 1-butene, having a total content of styrene units of from 1.0 to 30.0 wt.-%, preferably from 2.0 to 27.5 wt.-%, most preferably from 3.0 to 25.0 wt.-%, based on the total weight amount of the linear block copolymer (B).

### Definitions

A heterophasic polypropylene is a propylene-based copolymer with a semi-crystalline matrix phase, which can be a propylene homopolymer or a random copolymer of propylene and at least one alpha-olefin comonomer, and an elastomeric phase dispersed therein. The elastomeric phase can be a propylene copolymer with a high amount of comonomer, which is not randomly distributed in the polymer chain but are distributed in a comonomer-rich block structure and a propylene-rich block structure.

A heterophasic polypropylene usually differentiates from a one-phasic propylene copolymer in that it shows two distinct glass transition temperatures Tg which are attributed to the matrix phase and the elastomeric phase.

A propylene homopolymer is a polymer, which essentially consists of propylene monomer units. Due to impurities in the monomer feed of commercial polymerization processes a propylene homopolymer can comprise up to 0.1 mol % comonomer units, preferably up to 0.05 mol % comonomer units and most preferably up to 0.01 mol % comonomer units.

A propylene random copolymer is a copolymer of propylene monomer units and comonomer units in which the comonomer units are distributed randomly over the polypropylene chain. Thereby, a propylene random copolymer includes a fraction, which is insoluble in xylene—xylene cold insoluble (XCI) fraction—in an amount of at least 85 wt %, most preferably of at least 88 wt %, based on the total amount of propylene random copolymer. Accordingly, the propylene random copolymer does not contain an elastomeric polymer phase dispersed therein.

Usually, a propylene polymer comprising at least two propylene polymer fractions (components), which have been produced under different polymerization conditions resulting in different (weight average) molecular weights and/or different comonomer contents for the fractions, preferably produced by polymerizing in multiple polymerization stages with different polymerization conditions, is referred to as “multimodal”. The prefix “multi” relates to the number of different polymer fractions the propylene polymer is consisting of. As an example of multimodal propylene polymer, a propylene polymer consisting of two fractions only is called “bimodal”, whereas a propylene polymer consisting of three fractions only is called “trimodal”.

A unimodal propylene polymer only consists of one fraction.

Thereby, the term “different” means that the propylene polymer fractions differ from each other in at least one property, preferably in the weight average molecular weight—which can also be measured in different melt flow rates of the fractions—or comonomer content or both.

A block copolymer is a polymer comprising at least two different types of monomer units which are arranged in the polymeric chain in blocks of monomers units of one type. A block copolymer thus differs from a random copolymer in which the different types of monomer units are statically distributed in the polymeric chain.

A styrene-ethylene-1-butylene-styrene block copolymer comprises a block of styrene homopolymer followed by a block of ethylene-1-butylene elastomer followed by a block of styrene homopolymer in the polymeric chain. The two styrene homopolymer blocks are thereby arranged at both ends of the polymeric chain.

A styrene-ethylene-propylene-styrene block copolymer comprises a block of styrene homopolymer followed by a block of ethylene-propylene elastomer followed by a block of styrene homopolymer in the polymeric chain. The two styrene homopolymer blocks are thereby arranged at both ends of the polymeric chain.

Vis-breaking is a post reactor chemical process for modifying semi-crystalline polymers such as propylene polymers. During the vis-breaking process, the propylene polymer backbone is degraded, for example by means of peroxides, such as organic peroxides, via beta scission. The degradation is generally used for increasing the melt flow rate and narrowing the molecular weight distribution.

In the following amounts are given in % by weight (wt %) unless it is stated otherwise.

### DETAILED DESCRIPTION OF THE INVENTION

### Polypropylene Composition

The polypropylene composition in the at least one layer of the inventive cable comprises
(A) from 80.0 to 99.0 wt.-%, preferably from 82.5 to 97.2 wt. %, most preferably from 85.0 to 95.0 wt.-%, based on the total weight of the polypropylene composition, of a copolymer of propylene and comonomer units selected from ethylene and alpha-olefins having from 4 to 12 carbon atoms having
   a total amount of comonomer units of from 10.0 to 16.0 wt %, preferably from 11.0 to 15.0 wt %, most preferably from 12.0 to 14.0 wt %, based on the total amount of monomer units of the copolymer of propylene (A);
   a melt flow rate MFR₂ of from 0.5 to 5.0 g/10 min, preferably from 0.8 to 4.5 g/10 min, still more preferably from 1.0 to 4.3 g/10 min and most preferably from 1.2 to 4.0 g/10 min;
   a xylene cold soluble (XCS) fraction in a total amount of from 25.0 to 50.0 wt %, preferably from 27.5 to 45.0 wt %, more preferably from 30.0 to 42.5 wt % and most preferably from 32.5 to 40.0 wt %, based on the total weight amount of the copolymer of propylene (A); and
(B) from 1.0 to 20.0 wt.-%, preferably from 2.5 to 17.5 wt %, most preferably from 5.0 to 15.0 wt.-%, based on the total weight of the polypropylene composition, of a linear styrene block copolymer with a middle block containing sequences of ethylene, propylene and/or 1-butene, having a total content of styrene units of from 1.0 to 30.0 wt.-%, preferably from 2.0 to 27.5 wt.-%, most preferably from 3.0 to 25.0 wt.-%, based on the total weight amount of the linear block copolymer (B).

The polypropylene composition preferably comprises the copolymer of propylene and comonomer units selected from ethylene and alpha-olefins having from 4 to 12 carbon atoms (A) in an amount of from 80.0 to 99.0 wt.-%, preferably from 82.5 to 97.2 wt. %, most preferably from 85.0 to 95.0 wt.-% and a linear styrene block copolymer with a middle block containing sequences of ethylene, propylene and/or 1-butene (B) in an amount of from 1.0 to 20.0 wt.-%, preferably from 2.5 to 17.5 wt %, most preferably from 5.0 to 15.0 wt.-%, all based on the total weight of the polypropylene composition.

The polypropylene composition can further comprise polymeric components, which are different from the components (A) and (B), in an amount of preferably 0.0 to 10.0 wt % based on the total weight of the polypropylene composition.

In a preferred embodiment the polymeric components of the polypropylene composition consist of components (A) and (B).

Besides these polymeric components the polypropylene composition can comprise one or more additives in an amount of from 0.0 up to 5.0 wt %, based on the total weight of the polypropylene composition. The one or more additives are preferably selected from acid scavengers, antioxidants, alpha nucleating agents, beta nucleating agents, etc. Such additives are commercially available and for example described in “Plastic Additives Handbook”, 6th edition 2009 of Hans Zweifel (pages 1141 to 1190).

Usually, these additives are added in quantities of 1 to 50000 ppm for each single component.

The one or more additives can be added to the polymeric components in a blending step.

Thereby, the one or more additives can be added to the polymeric components in form of master batches in which one or more additives are blended with a carrier polymer in concentrated amounts. Any optional carrier polymer is calculated to the amount of additives, based on the total amount of the propylene copolymer composition.

The polypropylene composition preferably has a total amount of units derived from ethylene of from 7.5 to 25.0 wt %, more preferably from 10.0 to 22.5 wt % and most preferably from 12.5 to 20.0 wt %, based on the total amount of monomer units in the polypropylene composition.

Further, the polypropylene composition preferably has a total amount of units derived from propylene of from 70.0 to 90.0 wt %, more preferably from 72.5 to 87.5 wt % and most preferably from 75.0 to 85.0 wt %, based on the total amount of monomer units in the polypropylene composition.

Still further, the polypropylene composition preferably has a total amount of units derived from styrene of from 0.1 to 10.0 wt %, more preferably from 0.2 to 7.5 wt % and most preferably from 0.3 to 5.0 wt %, based on the total amount of monomer units in the polypropylene composition.

Furthermore, the polypropylene composition preferably has a total amount of units derived from 1-butene of from 0 to 12.5 wt %, more preferably from 0 to 10.0 wt % and most preferably from 0 to 7.5 wt %, based on the total amount of monomer units in the polypropylene composition.

Additionally, the polypropylene composition preferably has a total amount of units derived from butadiene of from 0 to 0.50 wt %, more preferably from 0 to 0.40 wt % and most preferably from 0 to 0.30 wt %, based on the total amount of monomer units in the polypropylene composition.

The polypropylene composition preferably has a xylene cold soluble (XCS) fraction in a total amount of from 30.0 to 55.0 wt %, more preferably from 32.5 to 52.5 wt %, still more preferably from 35.0 to 50.0 wt % and most preferably from 37.5 to 47.5 wt %, based on the total weight amount of the polypropylene composition.

The xylene cold soluble (XCS) fraction preferably has a total amount of units derived from ethylene of from 20.0 to 40.0 wt %, more preferably from 22.5 to 37.5 wt % and most preferably from 25.0 to 35.0 wt %, based on the total amount of monomer units in the xylene cold soluble (XCS) fraction.

Further, the xylene cold soluble (XCS) fraction preferably has a total amount of units derived from propylene of from 47.5 to 75.0 wt %, more preferably from 50.0 to 72.5 wt % and most preferably from 52.5 to 70.0 wt %, based on the total amount of monomer units in the xylene cold soluble (XCS) fraction.

Still further, the xylene cold soluble (XCS) fraction preferably has a total amount of units derived from styrene of from 0.3 to 15.0 wt %, more preferably from 0.5 to 12.5 wt % and most preferably from 0.7 to 10.0 wt %, based on the total amount of monomer units in the xylene cold soluble (XCS) fraction.

Furthermore, the xylene cold soluble (XCS) fraction preferably has a total amount of units derived from 1-butene of from 0 to 20.0 wt %, more preferably from 0 to 17.5 wt % and most preferably from 0 to 15.0 wt %, based on the total amount of monomer units in the xylene cold soluble (XCS) fraction.

Additionally, the xylene cold soluble (XCS) fraction preferably has a total amount of units derived from butadiene of from 0 to 1.00 wt %, more preferably from 0 to 0.80 wt % and most preferably from 0 to 0.60 wt %, based on the total amount of monomer units in the xylene cold soluble (XCS) fraction.

Further, the xylene cold soluble (XCS) fraction preferably has an intrinsic viscosity of from 150 to 300 cm³/g, preferably from 175 to 275 cm³/g and most preferably from 190 to 240 cm³/g, measured in decalin.

Additionally, the xylene cold soluble (XCS) fraction preferably has a weight average molecular weight Mw of from 150000 to 300000 g/mol, more preferably from 175000 to 325000 g/mol and most preferably from 200000 to 275000 g/mol.

Furthermore, the xylene cold soluble (XCS) fraction preferably has a polydispersity index, being the ratio of the weight average molecular weight and the number average molecular weight Mw/Mn, of from 3.5 to 8.5, preferably from 3.7 to 8.0 and most preferably from 4.0 to 7.5.

Further, the polypropylene composition has a fraction insoluble in cold xylene (XCI) preferably in a total amount of from 45.0 to 70.0 wt %, more preferably from 47.5 to 67.5 wt % still more preferably from 50.0 to 65.0 wt % and most preferably from 52.5 to 62.5 wt %, based on the total weight amount of the polypropylene composition.

In the polypropylene composition the xylene cold soluble (XCS) fraction and the fraction insoluble in cold xylene (XCI) add to 100 wt % of the polypropylene composition.

The fraction insoluble in cold xylene (XCI) preferably has a total amount of units derived from ethylene of from 0.7 to 10.0 wt %, more preferably from 1.0 to 8.5 wt % and most preferably from 2.5 to 7.5 wt %, based on the total amount of monomer units in the fraction insoluble in cold xylene (XCI).

Further, the fraction insoluble in cold xylene (XCI) preferably has a total amount of units derived from propylene of from 85.0 to 99.0 wt %, more preferably from 87.5 to 97.5 wt % and most preferably from 90.0 to 96.0 wt %, based on the total amount of monomer units in the fraction insoluble in cold xylene (XCI).

Still further, the fraction insoluble in cold xylene (XCI) preferably has a total amount of units derived from styrene of from 0 to 1.00 wt %, more preferably from 0 to 0.50 wt % and most preferably from 0 to 0.20 wt %, based on the total amount of monomer units in the fraction insoluble in cold xylene (XCI).

Furthermore, the fraction insoluble in cold xylene (XCI) preferably has a total amount of units derived from 1-butene of from 0 to 2.5 wt %, more preferably from 0 to 2.0 wt % and most preferably from 0 to 1.5 wt %, based on the total amount of monomer units in the fraction insoluble in cold xylene (XCI).

Additionally, the fraction insoluble in cold xylene (XCI) preferably has a total amount of units derived from butadiene of from 0 to 0.20 wt %, more preferably from 0 to 0.15 wt % and most preferably from 0 to 0.10 wt %, based on the total amount of monomer units in the fraction insoluble in cold xylene (XCI).

Further, the fraction insoluble in cold xylene (XCI) preferably has an intrinsic viscosity of from 200 to 375 cm³/g, preferably from 225 to 350 cm³/g and most preferably from 250 to 325 cm³/g, measured in decalin.

Additionally, the fraction insoluble in cold xylene (XCI) preferably has a weight average molecular weight Mw of from 250000 to 450000 g/mol, more preferably from 275000 to 425000 g/mol and most preferably from 300000 to 400000 g/mol.

Furthermore, the fraction insoluble in cold xylene (XCI) preferably has a polydispersity index, being the ratio of the weight average molecular weight and the number average molecular weight Mw/Mn, of from 3.5 to 7.5, preferably from 4.0 to 7.0 and most preferably from 4.5 to 6.5.

The ratio of the intrinsic viscosities of the XCI fraction to the XCS fraction (IV(XCI)/IV(XCS)) of the polypropylene composition is preferably in the range of from 1.0 to 1.7, more preferably from 1.0 to 1.5 and most preferably from 1.1 to 1.4.

The ratio of the weight average molecular weights of the XCI fraction to the XCS fraction (Mw(XCI)/Mw(XCS)) of the polypropylene composition is preferably in the range of from 1.35 to 1.75, more preferably from 1.40 to 1.70.

The polypropylene composition preferably has a melt flow rate MFR₂ of 0.5 to 2.5 g/10 min, preferably from 0.8 to 2.2 g/10 min, still more preferably from 1.0 to 2.0 g/10 min and most preferably from 1.2 to 1.9 g/10 min.

The polypropylene composition preferably has a flexural modulus of from 130 MPa to 350 MPa, more preferably of from 150 MPa to 340 MPa and most preferably of from 175 MPa to 325 MPa.

Preferably, the polypropylene composition has a Charpy notched impact strength at 23° C. of from 50 to 110 kJ/m², more preferably from 65 to 100 kJ/m² and most preferably from 70 to 95 kJ/m².

Further, the polypropylene composition preferably has a Charpy notched impact strength at −20° C. of from 7.5 to 80.0 kJ/m², more preferably from 8.5 to 75.0 kJ/m² and most preferably from 9.0 to 70.0 kJ/m².

Further, the polypropylene composition has a melting temperature Tm of from 140 to 159° C., preferably from 143 to 157° C. and most preferably from 145 to 153° C.

Additionally, the polypropylene composition preferably has a crystallization temperature Tc of from 85 to 130° C., more preferably from 87 to 128° C. and most preferably from 90 to 125° C.

The difference of the melting temperature to the crystallization temperature Tm-Tc is preferably in the range of from 20 to 65° C., preferably 25 to 60° C. and most preferably from 27 to 55° C.

The polypropylene composition preferably has at least two glass transition temperatures. Said two glass transition temperatures can be attributed to the matrix phase (Tg (matrix)) and the elastomeric phase (Tg (EP)).

Further, the polypropylene composition preferably has a glass temperature attributed to the matrix phase Tg (matrix) in the range of from −1.0 to ˜15.0° C., preferably from −2.5 to ˜12.5° C. and most preferably from −4.0 to ˜10.0° C.

Still further, the polypropylene composition preferably has a glass temperature attributed to the elastomeric phase Tg (EP) of from −35.0 to −55.0° C., preferably from −37.5 to −52.5° C. and most preferably from −40.0 to −50.0° C.

Preferably, the polypropylene composition has a shear thinning index SHI_{1/100} of from 2.5 to 20.0, more preferably from 5.0 to 17.5 and most preferably from 7.5 to 15.0.

Further, the polypropylene composition preferably has a polydispersity index PI of from 1.0 to 4.0 s⁻¹, more preferably from 1.5 to 3.5 s⁻¹ and most preferably from 2.0 to 3.0 s⁻¹.

Preferably, the polypropylene composition is prepared by melt blending the components (A) and (B), the optional additional polymeric components and the optional further additives, all as described above or below.

It is preferred that the polypropylene composition does not comprise, i.e. is free of a dielectric fluid, such as e.g. described in EP 2 739 679.

In the following, the copolymer of propylene and comonomer units selected from ethylene and alpha-olefins having from 4 to 12 carbon atoms (A) (abbreviated “copolymer of propylene (A)” or component (A)) and the linear styrene block copolymer with a middle block containing sequences of ethylene, propylene and/or 1-butene (B) (abbreviated “linear block copolymer (B)” or component (B)) described in more detail.

### Copolymer of Propylene (A)

The polypropylene composition according to the invention comprises a copolymer of propylene and comonomer units selected from ethylene and alpha-olefins having from 4 to 12 carbon atoms (A) (in the following “copolymer of propylene (A)”).

The comonomer units are selected from ethylene and alpha-olefins having from 4 to 12 carbon atoms, such as ethylene, 1-butene, 1-hexene or 1-octene. The copolymer of propylene (A) can comprise one type of comonomer units or two or more types such as two types of comonomer units. It is preferred that the copolymer of propylene (A) comprises one type of comonomer units. Especially preferred is ethylene.

The copolymer of propylene (A) preferably has a total amount of comonomer units, preferably of ethylene, of from 10.0 to 16.0 wt %, preferably from 11.0 to 15.0 wt %, most preferably from 12.0 to 14.0 wt %, based on the total amount of monomer units in the copolymer of propylene (A).

It is preferred that the copolymer of propylene (A) is a heterophasic copolymer of propylene.

The heterophasic propylene copolymer has a matrix phase and an elastomeric phase dispersed in said matrix phase.

The matrix phase is preferably a propylene random copolymer.

The comonomer units of said propylene random copolymer of the matrix phase usually are the same as for the copolymer of propylene as described above. Said comonomer units preferably are selected from ethylene and alpha-olefins having from 4 to 12 carbon atoms, such as ethylene, 1-butene, 1-hexene or 1-octene. The propylene random copolymer of the matrix phase can comprise one type of comonomer units or two or more types such as two types of comonomer units. It is preferred that the propylene random copolymer of the matrix phase comprises one type of comonomer units. Especially preferred is ethylene.

Heterophasic propylene copolymers are typically characterized by comprising at least two glass transition temperatures. Said two glass transition temperatures can be attributed to the matrix phase (Tg (matrix)) and the elastomeric phase (Tg (EP)).

The heterophasic propylene copolymer preferably has a glass transition temperature attributed to the matrix phase Tg (matrix) in the range of from −1.0 to ˜15.0° C., preferably from −2.5 to ˜12.5° C. and most preferably from −5.0 to ˜10.0° C.

Further, the heterophasic propylene copolymer preferably has a glass transition temperature attributed to the elastomeric phase Tg (EP) in the range of from −40.0 to −55.0° C., preferably from −42.5 to −52.5° C. and most preferably from −45.0 to −50.0° C.

In a copolymer of propylene (A), such as a heterophasic propylene copolymer, the matrix phase and the elastomeric phase usually cannot exactly be divided from each other. In order to characterize the matrix phase and the elastomeric phase of a heterophasic polypropylene copolymer several methods are known. One method is the extraction of a fraction, which contains to the most part the elastomeric phase with xylene, thus separating a xylene cold solubles (XCS) fraction from a xylene cold insoluble (XCI) fraction. The XCS fraction contains for the most part the elastomeric phase and only a small part of the matrix phase whereas the XCI fraction contains for the most part the matrix phase and only a small part of the elastomeric phase.

The copolymer of propylene (A) preferably has a xylene cold soluble (XCS) fraction in a total amount of from 25.0 to 50.0 wt %, more preferably from 27.5 to 45.0 wt %, still more preferably from 30.0 to 42.5 wt % and most preferably from 32.5 to 40.0 wt %, based on the total weight amount of the copolymer of propylene (A).

The xylene cold soluble (XCS) fraction preferably has an amount of comonomer units, preferably of ethylene, of from 23.0 to 35.0 wt %, more preferably from 23.5 to 32.5 wt % and most preferably from 24.0 wt % to 30.0 wt %, based on the total amount of monomer units in the xylene cold soluble (XCS) fraction.

Further, the xylene cold soluble (XCS) fraction preferably has an intrinsic viscosity of from 150 to 350 cm³/g, preferably from 200 to 325 cm³/g and most preferably from 225 to 300 cm³/g, measured in decalin.

Additionally, the xylene cold soluble (XCS) fraction preferably has a weight average molecular weight Mw of from 185000 to 350000 g/mol, more preferably from 200000 to 325000 g/mol and most preferably from 210000 to 315000 g/mol.

Furthermore, the xylene cold soluble (XCS) fraction preferably has a polydispersity index, being the ratio of the weight average molecular weight and the number average molecular weight Mw/Mn, of from 3.5 to 8.5, preferably from 3.7 to 8.0 and most preferably from 4.0 to 7.5.

Further, the copolymer of propylene (A) has a fraction insoluble in cold xylene (XCI) preferably in a total amount of from 50.0 to 75.0 wt %, more preferably from 55.0 to 72.5 wt %, still more preferably from 57.5 to 70.0 wt % and most preferably from 60.0 to 67.5 wt %, based on the total weight amount of the copolymer of propylene (A).

The fraction insoluble in cold xylene (XCI) preferably has an amount of comonomer units, preferably of ethylene, of from 3.0 to 9.0 wt %, preferably from 4.0 to 8.5 wt % and most preferably from 4.5 to 7.5 wt %, based on the total amount of monomer units in the fraction insoluble in cold xylene (XCI).

Further, the fraction insoluble in cold xylene (XCI) preferably has an intrinsic viscosity of from 185 to 350 cm³/g, preferably from 220 to 325 cm³/g and most preferably from 210 to 300 cm³/g, measured in decalin.

Additionally, the fraction insoluble in cold xylene (XCI) preferably has a weight average molecular weight Mw of from 225000 to 450000 g/mol, more preferably from 240000 to 425000 g/mol and most preferably from 260000 to 400000 g/mol.

Furthermore, the fraction insoluble in cold xylene (XCI) preferably has a polydispersity index, being the ratio of the weight average molecular weight and the number average molecular weight Mw/Mn, of from 3.5 to 7.5, preferably from 3.7 to 7.0 and most preferably from 4.0 to 6.5.

The ratio of the intrinsic viscosities of the XCI fraction to the XCS fraction of the copolymer of propylene is preferably in the range of from 0.9 to 1.5, more preferably from 1.0 to 1.4 and most preferably from 1.0 to 1.3.

The copolymer of propylene (A) preferably has a melt flow rate MFR₂ of 0.5 to 2.5 g/10 min, preferably from 0.8 to 2.3 g/10 min, still more preferably from 1.0 to 2.0 g/10 min and most preferably from 1.2 to 1.7 g/10 min.

The copolymer of propylene (A) preferably has a flexural modulus of from 130 MPa to 400 MPa, more preferably of from 150 MPa to 390 MPa and most preferably of from 175 MPa to 380 MPa.

Preferably, the copolymer of propylene (A) has a Charpy notched impact strength at 23° C. of from 50 to 110 kJ/m², more preferably from 65 to 100 kJ/m² and most preferably from 75 to 95 kJ/m².

Further, the copolymer of propylene (A) preferably has a Charpy notched impact strength at −20° C. of from 5.0 to 10.0 kJ/m², more preferably from 5.5 to 9.0 kJ/m² and most preferably from 6.0 to 8.0 kJ/m².

Further, the copolymer of propylene (A) has a melting temperature Tm of from 140 to 159° C., preferably from 143 to 157° C. and most preferably from 145 to 153° C.

Additionally, the copolymer of propylene (A) has a crystallization temperature Tc of from 85 to 130° C., preferably from 87 to 128° C. and most preferably from 90 to 125° C.

The difference of the melting temperature to the crystallization temperature Tm-Tc is preferably in the range of from 20 to 65° C., preferably 25 to 60° C. and most preferably from 27 to 55° C.

It is preferred that the copolymer of propylene (A) has an intrinsic viscosity of from 185 to 350 cm³/g, preferably from 200 to 325 cm³/g and most preferably from 210 to 300 cm³/g, measured in decalin.

The copolymer of propylene (A) can be polymerized in a sequential multistage polymerization process, i.e. in a polymerization process in which two or more polymerization reactors are connected in series. Preferably, in the sequential multistage polymerization process, two or more, more preferably three or more, such as three or four, polymerization reactors are connected in series. The term “polymerization reactor” shall indicate that the main polymerization takes place. Thus in case the process consists of four polymerization reactors, this definition does not exclude the option that the overall process comprises for instance a pre-polymerization step in a pre-polymerization reactor.

When the copolymer of propylene (A) is a heterophasic propylene copolymer, the matrix phase of the heterophasic propylene copolymer is polymerized in first polymerization reactor for producing a unimodal matrix phase or in the first and second polymerization reactor for producing a multimodal matrix phase. The elastomeric phase of the heterophasic propylene copolymer is preferably polymerized in the subsequent one or two polymerization reactor(s) in the presence of the matrix phase for producing a unimodal elastomeric phase or a multimodal elastomeric phase.

Preferably, the polymerization reactors are selected from slurry phase reactors, such as loop reactors and/or gas phase reactors such as fluidized bed reactors, more preferably from loop reactors and fluidized bed reactors.

A preferred sequential multistage polymerization process is a “loop-gas phase”-process, such as developed by Borealis A/S, Denmark (known as BORSTAR® technology) described e.g. in patent literature, such as in EP 0 887 379, WO 92/12182 WO 2004/000899, WO 2004/111095, WO 99/24478, WO 99/24479 or in WO 00/68315.

A further suitable slurry-gas phase process is the Spheripol® process of LyondellBasell.

Suitable sequential polymerization processes for polymerizing the copolymer of propylene (A), preferably the heterophasic propylene copolymer, are e.g. disclosed in EP 1 681 315 A1 or WO 2013/092620 A1.

The copolymer of propylene (A), preferably the heterophasic propylene copolymer can be polymerized in the presence of a Ziegler-Natta catalyst or a single site catalyst.

Suitable Ziegler-Natta catalysts are e.g. disclosed in U.S. Pat. No. 5,234,879, WO 92/19653, WO 92/19658, WO 99/33843, WO 03/000754, WO 03/000757, WO 2013/092620 A1 or WO 2015/091839.

Suitable single site catalysts are e.g. disclosed in WO 2006/097497, WO 2011/076780 or WO 2013/007650.

The Ziegler-Natta catalyst or single site catalyst of said list are only suitable for producing isotactic polypropylenes.

The copolymer of propylene (A) is preferably an isotactic copolymer of propylene.

The copolymer of propylene (A) is preferably not subjected to a visbreaking step as e.g. described in WO 2013/092620 A1.

Heterophasic propylene copolymer resins suitable as copolymer of propylene (A) are also commercially available. These resins are usually already additivated with stabilizer packages. Thus, when using commercially available resins as copolymer of propylene the addition of additives as described above might have to be adjusted to the already present additives.

### Linear Block Copolymer (B)

The polypropylene composition according to the invention comprises a linear styrene block copolymer with a middle block containing sequences of ethylene, propylene and/or 1-butene (B) (in the following “linear block copolymer (B)”).

The linear block copolymer (B) is preferably a styrene-ethylene-1-butene-styrene triblock copolymer (SEBS) or a styrene-ethylene-propylene-styrene triblock copolymer (SEPS).

In one embodiment the linear block copolymer (B) is a styrene-ethylene-1-butene-styrene triblock copolymer (SEBS).

The styrene-ethylene-1-butene-styrene triblock copolymer (SEBS) preferably has an amount of units derived from ethylene of from 85.0 to 98.9 wt %, more preferably from 89.0 to 97.7 wt % and most preferably from 91.5 to 96.5 wt %, based on the total amount of monomer units in the styrene-ethylene-1-butene-styrene triblock copolymer (SEBS).

Still further, the styrene-ethylene-1-butene-styrene triblock copolymer (SEBS) preferably has an amount of units derived from styrene of from 1.0 to 10.0 wt %, more preferably from 2.0 to 7.5 wt % and most preferably from 3.0 to 6.0 wt %, based on the total amount of monomer units in the styrene-ethylene-1-butene-styrene triblock copolymer (SEBS).

Additionally, the styrene-ethylene-1-butene-styrene triblock copolymer (SEBS) preferably has an amount of units derived from butadiene of from 0.1 to 5.0 wt %, more preferably from 0.2 to 3.5 wt % and most preferably from 0.3 to 2.5 wt %, based on the total amount of monomer units in the styrene-ethylene-1-butene-styrene triblock copolymer (SEBS).

The styrene-ethylene-1-butene-styrene triblock copolymer (SEBS) preferably has a melt flow rate MFR₂ of 1.0 to 10.0 g/10 min, preferably from 2.0 to 8.5 g/10 min, most preferably from 2.5 to 7.5 g/10 min.

Further, the styrene-ethylene-1-butene-styrene triblock copolymer (SEBS) has a melting temperature Tm of from 50 to 100° C., preferably from 55 to 95° C. and most preferably from 60 to 90° C.

Additionally, the styrene-ethylene-1-butene-styrene triblock copolymer (SEBS) preferably has a crystallization temperature Tc of from 5 to 50° C., more preferably from 7 to 45° C. and most preferably from 10 to 40° C.

The difference of the melting temperature to the crystallization temperature Tm-Tc is preferably in the range of from 20 to 65° C., preferably 25 to 60° C. and most preferably from 30 to 55° C.

Further, the styrene-ethylene-1-butene-styrene triblock copolymer (SEBS) preferably has a glass temperature of from −30 to −50° C., preferably from −32 to −47° C. and most preferably from −35 to −45° C.

Preferably, the styrene-ethylene-1-butene-styrene triblock copolymer (SEBS) has a shear thinning index SHI_{1/100} of from 1.0 to 7.5, more preferably from 1.2 to 6.5 and most preferably from 1.5 to 6.0.

Further, the styrene-ethylene-1-butene-styrene triblock copolymer (SEBS) preferably has a polydispersity index PI of from 0.2 to 1.5 s⁻¹, more preferably from 0.4 to 1.3 s⁻¹ and most preferably from 0.6 to 1.1 s⁻¹.

Further, the styrene-ethylene-1-butene-styrene triblock copolymer (SEBS) preferably has a density of from 860 to 895 kg/m³, more preferably from 865 to 890 kg/m³ and most preferably from 870 to 885 kg/m³.

In the presence of the styrene-ethylene-1-butene-styrene triblock copolymer (SEBS) as linear block copolymer (B) the polypropylene composition preferably has the following comonomer contents when measured by NMR measurement:
a total amount of units derived from propylene of from 70.0 to 85.0 wt.-%, more preferably from 72.5 to 82.5 wt.-%, most preferably from 75.0 to 80.0 wt.-%;
a total amount of units derived from ethylene of from 7.5 to 22.5 wt.-%, more preferably from 10.0 to 20.0 wt.-%, most preferably from 12.5 to 17.5 wt.-%;
a total amount of units derived from 1-butene of from 1.0 to 12.5 wt.-%, more preferably from 2.0 to 10.0 wt.-%, most preferably from 3.0 to 7.5 wt.-%;
a total amount of units derived from butadiene of from 0.01 to 0.50 wt.-%, more preferably from 0.02 to 0.40 wt.-%, most preferably from 0.05 to 0.30 wt.-%; and
a total amount of units derived from styrene of from 0.1 to 1.5 wt.-%, more preferably from 0.2 to 1.2 wt.-%, most preferably from 0.3 to 1.0 wt.-%,
all based on the total molar amount monomer units of the polypropylene composition.

In the presence of the styrene-ethylene-1-butene-styrene triblock copolymer (SEBS) as linear block copolymer (B) the polypropylene composition preferably has xylene cold soluble (XCS) fraction, which preferably has
a total amount of units derived from propylene of from 47.5 to 62.5 wt.-%, more preferably from 50.0 to 60.0 wt.-%, most preferably from 52.5 to 57.5 wt.-%;
a total amount of units derived from ethylene of from 20.0 to 40.0 wt.-%, more preferably from 22.5 to 37.5 wt.-%, most preferably from 25.0 to 35.0 wt.-%;
a total amount of units derived from 1-butene of from 5.0 to 20.0 wt.-%, more preferably from 7.5 to 17.5 wt.-%, most preferably from 10.0 to 15.0 wt.-%;
a total amount of units derived from butadiene of from 0.05 to 1.00 wt.-%, more preferably from 0.10 to 0.80 wt.-%, most preferably from 0.15 to 0.60 wt.-%; and
a total amount of units derived from styrene of from 0.3 to 2.5 wt.-%, more preferably from 0.5 to 2.0 wt.-%, most preferably from 0.7 to 1.5 wt.-%,
all based on the total molar amount monomer units of the xylene cold soluble (XCS) fraction; and/or
a fraction insoluble in cold xylene (XCI), which preferably has
a total amount of units derived from propylene of from 85.0 to 99.0 wt.-%, more preferably from 87.5 to 97.5 wt.-%, most preferably from 90.0 to 95.0 wt.-%;
a total amount of units derived from ethylene of from 0.7 to 10.0 wt.-%, more preferably from 1.0 to 8.0 wt.-%, most preferably from 2.5 to 7.5 wt.-%;
a total amount of units derived from 1-butene of from 0.1 to 2.5 wt.-%, more preferably from 0.1 to 2.0 wt.-%, most preferably from 0.1 to 1.5 wt.-%;
a total amount of units derived from butadiene of from 0 to 0.20 wt.-%, more preferably from 0 to 0.15 wt.-%, most preferably from 0 to 0.10 wt.-%; and
a total amount of units derived from styrene units of from 0 to 0.20 wt.-%, more preferably from 0 to 0.15 wt.-%, most preferably from 0 to 0.10 wt.-%,
all based on the total molar amount monomer units of the having fraction insoluble in cold xylene (XCI).

In another embodiment the linear block copolymer (B) is a styrene-ethylene-propylene-styrene triblock copolymer (SEPS).

The styrene-ethylene-propylene-styrene triblock copolymer (SEPS) preferably has a total content of styrene units of from 10.0 to 30.0 wt.-%, preferably from 12.5 to 27.5 wt.-%, most preferably from 15.0 to 25.0 wt.-%, based on the total weight amount of the linear block copolymer (B).

Further, the styrene-ethylene-propylene-styrene triblock copolymer (SEPS) preferably has styrene to ethylene/propylene (S/EP) weight ratio of from 10.0:9.0 to 30.0:70.0, more preferably from 12.5:87.5 to 27.5:72.5, most preferably from 15.0:85.0 to 25.0 to 75.0.

Still further, the styrene-ethylene-propylene-styrene triblock copolymer (SEPS) preferably has a melt flow rate MFR₅ of from 1.0 to 25.0 g/10 min, preferably from 2.5 to 22.5 g/10 min, most preferably from 5.0 to 20.0 g/10 min, determined according to ASTM D 1238 at 230° C. and 5 kg.

Additionally, the styrene-ethylene-propylene-styrene triblock copolymer (SEPS) preferably has a density of from 880 to 915 kg/m³, preferably from 885 to 910 kg/m³, mot preferably from 890 to 905 kg/m³, determined according to ASTM D 792.

Furthermore, the styrene-ethylene-propylene-styrene triblock copolymer (SEPS) preferably has a shore A hardness of from 40 to 75, preferably from 45 to 70, most preferably from 50 to 65, determined according to ASTM D 2240.

The linear block copolymer (B) can be produced by any suitable means for producing a linear block copolymer comprising styrene, monomer units selected from ethylene, propylene and/or 1-butene. Styrene-ethylene-1-butene-styrene triblock copolymers (SEBS) are usually produced by hydrogenation from styrene-butadiene-styrene block copolymers (SBS). Styrene-ethylene-propylene-styrene block copolymers (SEPS) are usually produced by hydrogenation from styrene-isoprene-styrene block copolymers (SIS).

Styrene-ethylene-1-butene-styrene triblock copolymer (SEBS) resins and styrene-ethylene-propylene-styrene triblock copolymer (SEPS) resins suitable as linear block copolymer (B) are also commercially available. These resins are usually already additivated with stabilizer packages. Thus, when using commercially available resins as linear block copolymer (B) the addition of additives as described above might have to be adjusted to the already present additives.

### Cable

The present invention relates to a cable comprising at least one layer comprising the polypropylene composition as defined above or below.

The cable preferably comprises an insulation layer comprising the polypropylene composition as described above or below.

The cable usually comprises of at least one conductor and at least one insulation layer comprising the polypropylene composition as described above or below.

The term “conductor” means herein above and below that the conductor comprises one or more wires. The wire can be for any use and be e.g. optical, telecommunication or electrical wire. Moreover, the cable may comprise one or more such conductors. Preferably the conductor is an electrical conductor and comprises one or more metal wires. The cable is preferably a power cable. A power cable is defined to be a cable transferring energy operating at any voltage, typically operating at voltages higher than 1 kV. The voltage applied to the power cable can be alternating (AC), direct (DC), or transient (impulse). The polypropylene composition of the invention is very suitable for power cables, especially for power cables operating at voltages 6 kV to 36 kV (medium voltage (MV) cables) and at voltages higher than 36 kV, known as high voltage (HV) cables and extra high voltage (EHV) cables, which EHV cables operate, as well known, at very high voltages. The terms have well known meanings and indicate the operating level of such cables.

For low voltage applications the cable system typically either consists of one conductor and one insulation layer comprising the polypropylene composition as described above or below, or of one conductor, one insulation layer comprising the polypropylene composition as described above or below and an additional jacketing layer, or of one conductor, one semiconductive layer and one insulation layer comprising the polypropylene composition as described above or below.

For medium and high voltage applications the cable system typically consists of one conductor, one inner semiconductive layer, one insulation layer comprising the polypropylene composition as described above or below and one outer semiconductive layer, optionally covered by an additionally jacketing layer.

The semiconductive layers mentioned preferably comprise, more preferably consist of a thermoplastic polyolefin composition, preferably a polyethylene composition or a polypropylene composition, containing a sufficient amount of electrically conducting solid fillers preferably carbon black. It is preferred that the thermoplastic polyolefin composition of the semiconductive layer(s) is a polypropylene composition, more preferably a polypropylene composition comprising a heterophasic propylene copolymer as polymeric component. It is especially preferred that the thermoplastic polyolefin composition of the at least one semiconductive layer, preferably both semiconductive layers of the cable, comprise the same copolymer of propylene as the insulation layer, i.e. the copolymer of propylene as described above or below.

The cable comprising an insulation layer comprising the polypropylene composition according to the invention as described above shows good AC electric breakdown strength in form of Weibull alpha-value and Weibull beta-value.

The cable preferably has a Weibull alpha-value of from 35.0 to 65.0 kV/mm, preferably from 37.5 to 65.0 kV/mm and most preferably from 40.0 to 65.0 kV/mm, when measured on a 10 kV cable.

Still further, the cable preferably has a Weibull beta-value of from 5.0 to 250.0, preferably from 5.5 to 250.0, most preferably from 6.0 to 250.0, when measured on a 10 kV cable.

Thus, the insulation layer comprising the polypropylene composition according to the invention can be used for medium and high voltage cables.

In yet another aspect the present invention relates to the use of the polypropylene composition as described above or below as cable insulation for medium and high voltage cables.

Said medium and high voltage cables preferably meet all properties requirements as described for the cables above and below.

### Benefits of the Invention

The polypropylene composition shows a good balance of properties regarding high flexibility, a good mechanical strength, good impact properties and high crystallization and melting temperature which allow the use as cable insulation e.g. for medium and high voltage cables at high operation temperatures. By adding the linear block copolymer (B) to the polypropylene composition the flexibility and the impact properties can be further improved whereby the high crystallization and melting temperature are maintained.

It has been found that even with melt flow rates as low as 0.5 to 2.5 g/10 min the polypropylene composition can be easily compounded to prepare the insulation layer without need of increasing the melt flow rate via visbreaking the composition or the copolymer of propylene (A).

Cables comprising an insulation layer comprising the inventive polypropylene composition surprisingly show good AC breakdown strength in form of Weibull alpha-value and Weibull beta-value. Thereby, the addition of the linear block copolymer (B) to the polypropylene composition further improves the AC breakdown strength compared to polypropylene compositions which only include the copolymer of propylene (A) as polymeric compound.

The good AC breakdown strength in form of Weibull alpha-value and Weibull beta-value can be obtained without addition of a dielectric fluid such as e.g. described in EP 2 739 679.

### EXAMPLES

The following definitions of terms and determination methods apply for the above general description of the invention as well as to the below examples unless otherwise defined.

### 1. Measurement Methods

### a) Melt Flow Rate (MFR₂)

The melt flow rate is the quantity of polymer in grams which the test apparatus standardized to ISO 1133 or ASTM D1238 extrudes within 10 minutes at a certain temperature under a certain load.

The melt flow rate MFR₂ of propylene based polymers and the polypropylene composition is measured at 230° C. with a load of 2.16 kg according to ISO 1133.

The melt flow rate MFR₂ of the linear styrene block copolymers is measured at 230° C. with a load of 2.16 kg according to ISO 1133.

The melt flow rate MFR₅ of the linear styrene block copolymers is measured at 230° C. with a load of 5 kg according to ISO 1133.

The melt flow rate can also be measured according to ASTM D 1238.

### b) Density

Density is measured according to ISO 1183. Sample preparation is done by compression moulding in accordance with ISO 17855-2.

The density can also be measured according to ASTM D 792.

### c) Comonomer Content

### Method I (HECOs)

### Comonomer Content Quantification of Poly(Propylene-Co-Ethylene) Copolymers

Quantitative ¹³C{¹H} NMR spectra were recorded in the solution-state using a Bruker Avance NEO 400 NMR spectrometer operating at 400.15 and 100.62 MHz for ¹H and ¹³C respectively. All spectra were recorded using a ¹³C optimised 10 mm extended temperature probe head at 125° C. using nitrogen gas for all pneumatics. Approximately 200 mg of material was dissolved in 3 ml of 1,2-tetrachloroethane-d₂ (TCE-d₂) along with chromium-(III)-acetylacetonate (Cr(acac)₃) resulting in a 60 mM solution of relaxation agent in solvent {8} and with approximately 3 mg BHT (2,6-di-tert-butyl-4-methylphenol CAS 128-37-0). To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme {3, 4}. A total of 6144 (6k) transients were acquired per spectra. Quantitative ¹³C{¹H} NMR spectra were processed, integrated and relevant quantitative properties determined from the integrals using proprietary computer programs. All chemical shifts were indirectly referenced to the central methylene group of the ethylene block (EEE) at 30.00 ppm using the chemical shift of the solvent. This approach allowed comparable referencing even when this structural unit was not present. Characteristic signals corresponding to the incorporation of ethylene were observed {7}.

The comonomer fraction was quantified using the method of Wang et. al. {6} through integration of multiple signals across the whole spectral region in the ¹³C{¹H} spectra. This method was chosen for its robust nature and ability to account for the presence of regiodefects when needed. Integral regions were slightly adjusted to increase applicability across the whole range of encountered comonomer contents. For systems where only isolated ethylene in PPEPP sequences was observed the method of Wang et al. was modified to reduce the influence of non-zero integrals of sites that are known to not be present. This approach reduced the overestimation of ethylene content for such systems and was achieved by reduction of the number of sites used to determine the absolute ethylene content to:

E=0.5(Sββ+Sβγ+Sβδ+0.5(Sαβ+Sαγ))

Through the use of this set of sites the corresponding integral equation becomes:

E=0.5(I_{H}+I_{G}+0.5(I_{C}+I_{D}))

using the same notation used in the article of Wang et al. {6}. Equations used for absolute propylene content were not modified.

The mole percent comonomer incorporation was calculated from the mole fraction:

E[mol %]=100*fE

The weight percent comonomer incorporation was calculated from the mole fraction:

E[wt %]=100*(fE*28.06)/((fE*28.06)+((1−fE)*42.08))

### BIBLIOGRAPHIC REFERENCES

1) Busico, V., Cipullo, R., Prog. Polym. Sci. 26 (2001) 443.
2) Busico, V., Cipullo, R., Monaco, G., Vacatello, M., Segre, A. L., Macromolecules 30 (1997) 6251.
3) Zhou, Z., Kuemmerle, R., Qiu, X., Redwine, D., Cong, R., Taha, A., Baugh, D. Winniford, B., J. Mag. Reson. 187 (2007) 225.
4) Busico, V., Carbonniere, P., Cipullo, R., Pellecchia, R., Severn, J., Talarico, G., Macromol. Rapid Commun. 2007, 28, 1128.
5) Resconi, L., Cavallo, L., Fait, A., Piemontesi, F., Chem. Rev. 2000, 100, 1253.
6) Wang, W-J., Zhu, S., Macromolecules 33 (2000), 1157.
7) Cheng, H. N., Macromolecules 17 (1984), 1950.
8) Singh, G., Kothari, A., Gupta, V., Polymer Testing 28 5 (2009), 475.
9) Kakugo, M., Naito, Y., Mizunuma, K., Miyatake, T. Macromolecules 15 (1982) 1150.
10) Randall, J. Macromol. Sci., Rev. Macromol. Chem. Phys. 1989, C29, 201.
11) Resconi, L., Cavallo, L., Fait, A., Piemontesi, F., Chem. Rev. 2000, 100, 1253.

### Method II (Composites)

### Quantification of the Styrene(s) and Butadiene (BD) Content

Quantitative ¹³C{¹H} NMR spectra recorded in solution-state using a Bruker Avance III 400 NMR spectrometer operating at 400.15 and 100.62 MHz for ¹H and ¹³C respectively. All spectra were recorded using a ¹³C optimised 10 mm selective excitation probehead at 125° C. using nitrogen gas for all pneumatics. Approximately 200 mg of material was dissolved in 1,2-tetrachloroethane-d₂ (TCE-d₂), using approximately 3 mg of BHT (CAS 128-37-0) as stabiliser.

Standard single-pulse excitation was employed utilising a 30 degree pulse, a relaxation delay of 3 s and 10 Hz sample rotation. 16 transients were acquired per spectra using 4 dummy scans. A total of 32k data points were collected per FID with a dwell time of 60 μs, which corresponded to a spectral window of approx. 20 ppm. The FID was then zero filled to 64k data points and an exponential window function applied with 0.3 Hz line-broadening.

Quantitative ¹H NMR spectra were processed, integrated and quantitative properties determined. All chemical shifts were internally referenced to the residual protonated solvent signal at 5.95 ppm. Characteristic signals corresponding to styrene, vinylene and aliphatic bulk (polyethylene, polypropylene were observed (A. J. Brandolini, D. D. Hills, “NMR spectra of polymers and polymer additives”, Marcel Deker Inc., 2000) and contents calculated.

Characteristic signals resulting from the additional use of BHT as stabiliser were observed. For the BHT compensation, the integral of the signal at 4.8 ppm assigned to the —OH site of BHT was used, accounting for the number of reporting nuclei per molecule:

BHT=I_{OH-BHT}

Characteristic signals resulting from styrene were observed and the content was quantified using the integral of the aromatic signals (I_{aromatic}) between 7.4 ppm and 6.5 ppm assigned to aromatic protons, accounting for the number of reporting nuclei per styrene. Aromatic protons from BHT influencing integral region (I_{aromatic}) must be compensated for:

S=[I_{aromatic}−(2*BHT)]/5

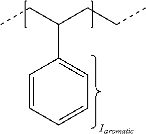

Characteristic signals resulting from vinylene in terms of 1,4-butadiene (R—CH═CH—R′) and ally in terms of 1,2-butadiene (CH₂═CH—RR′) were observed between 5.6 ppm and 5.3 ppm (I_{1,4}) and between 5.3 ppm and 5.0 ppm (I_{1,2}) respectively. Compensation of I_{1,4} by one proton of I_{1,2} required due to signal overlap as described in A. J. Brandolini, D. D. Hills, “NMR spectra of polymers and polymer additives”, Marcel Deker Inc., 2000. Both unsaturated species are combined and quantified as butadiene:

$$BD = [ {I}_{1 , 2} + ( {I}_{1 , 4} - {I}_{1 , 2} / 2 ) ] / 2$$

The aliphatic bulk content was quantified using the integral of the bulk aliphatic (I_{bulk}) signal between 0.0-2.8 ppm. This integral included the aliphatic sites from styrene (CH and CH₂) and the aliphatic sites from BHT as well. The bulk content was calculated based on the bulk integral and compensating for aliphatic styrene signals and BHT, accounting for the number of reporting nuclei per bulk.

$$bulk = [ {I}_{bulk} - ( 21 * BHT ) - ( 3 * S ) ] / 4$$

The mole fraction of styrene and vinylene as butadiene in the polymer was calculated as:

$$fS = S / ( S + BD + bulk )$$

$$fBD = BD / ( S + BD + bulk )$$

The styrene and vinylene as butadiene content in mole percent was calculated as:

$$S [ mol \% ] = 100 * fS$$

$$BD [ mol \% ] = 100 * fBD$$

The styrene and vinylene as butadiene content in weight percent was calculated as:

$$S [ wt \% ] = ( 100 * fS * 10 \text{} 4.1 \text{} 5 ) \text{} / [ \text{} ( fS * 104.15 ) + ( fBD * 54.09 ) + ( ( 1 - fS - fBD ) * 28.05 ) ]$$

$$BD [ wt \% ] = ( 100 * fBD * 54.09 ) \text{} / [ \text{} ( fS * 104. 15 ) + ( fBD * 54.09 ) + ( ( 1 - fS - fBD ) * 28.05 ) ]$$

### Quantification of the Total C2, C3 and C4 Content in Composites

Quantitative ¹³C{¹H} NMR spectra were recorded in the solution-state using a Bruker Avance Neo 400 NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics. Approximately 200 mg of material was dissolved in approximately 3 ml of 1,2-tetrachloroethane-d₂ (TCE-d₂) along with approximately 3 mg BHT (2,6-di-tert-butyl-4-methylphenol CAS 128-37-0) and chromium-(III)-acetylacetonate (Cr(acac)₃) resulting in a 60 mM solution of relaxation agent in solvent as described in G. Singh, A. Kothari, V. Gupta, Polymer Testing 2009, 28(5), 475.

To ensure a homogenous solution, after initial sample preparation in a heat block, the NMR tube was further heated in a rotatory oven for at least 1 hour. Upon insertion into the magnet the tube was spun at 10 Hz.

Standard single-pulse excitation was employed without NOE, using an optimised tip angle, 1 s recycle delay and a bi-level WALTZ16 decoupling scheme as described in Z. Zhou, R. Kuemmerle, X. Qiu, D. Redwine, R. Cong, A. Taha, D. Baugh, B. Winniford, J. Mag. Reson. 187 (2007) 225 and V. Busico, P. Carbonniere, R. Cipullo, C. Pellecchia, J. Severn, G. Talarico, Macromol. Rapid Commun. 2007, 28, 1128. A total of 6144 (6k) transients were acquired per spectra.

Quantitative ¹³C{¹H} NMR spectra were processed, integrated and relevant quantitative properties determined from the integrals. All chemical shifts were indirectly referenced to the central methylene group of the ethylene block (EEE) at 30.00 ppm using the chemical shift of the solvent. This approach allowed comparable referencing even when this structural unit was not present.

Characteristic signals corresponding to various incorporations of ethylene, as described in Cheng, H. N., Macromolecules 1984, 17, 1950 and signals from SEBS, as described in A. J. Brandolini, D. D. Hills, “NMR spectra of polymers and polymer additives”, Marcel Deker Inc., 2000, were observed.

The comonomer fraction was quantified using a comparable triad approach as reported by L. Abis, Mackromol. Chem. 187, 1877-1886 (1986) for ZN C2C3 copolymers but with introduction of C4 quantification and establishing a compensation routine for overlapping signals. Caused by the complex C4 incorporation structure of the SEBS materials the only possibility to get total amount of C4 in the blend was utilised by use of 1B2 site between 11.80 ppm and 10.00 ppm reflecting all existing C4 sequences.

In terms of C2 content only the total amount resulting from both C2C3 and SEBS blend component can be quantified by use of the methylene sequence at 30.0 ppm.

assignment table ¹³C NMR spectra

| chemical shift [ppm] | assignment | label |
|---|---|---|
| 33.4 | EPE (CH) | A |
| 31.3-30.7 | PPE (CH) + Sgg + BHT | B |
| 30.4 | Sgd (C2C3, C2C4) | C |
| 29.9 | Sdd (C2C3, C2C4) | D |
| 29.6-28.2 | PPP (CH) | E |
| 27.8-26.5 | Sbd + 2B2 | F |
| 25.2-24.3 | Sbb | G |
| 12.0-10.0 | EBE, EBB, BBB | H |
| 152 | quart C BHT | BHT |

triad equations

| triad sequence | signal/equation |
|---|---|
| PEP | G |
| PEE | F − H |
| EEE | D/2 + C/4 |
| PPP | E |
| PPE | (B − 6* BHT) − (((F − H) − C)/2) |
| EPE | A |
| XBX | H |

After quantification of the mol fraction and normalisation, the amounts of C2, C3 and C4 can be calculated by summing the E, P and B centered triads:

$$sum of triads = PEP + PEE + EE + PPP + PPE + EPE + XBX$$

$$\begin{matrix}fmol PEP = PEP / sum of triads & mol \% PEP = fmol PEP * 100 \\ fmol PEE = PEE / sum of triads & mol \% PEE = fmol PEE * 100 \\ fmol EEE = EEE / sum of triads & mol \% EEE = fmol EEE * 100 \\ fmol PPP = PPP / sum of triads & mol \% PPP = fmol PPP * 100 \\ fmol PPE = PPE / sum of triads & mol \% PPE = fmol PPE * 100 \\ fmol EPE = EPE / sum of triads & mol \% EPE = fmol EPE * 100 \\ fmol XBX = XBX / sum of triads & mol \% XBX = fmol XBX * 100\end{matrix}$$

$$C 2 [ mol \% ] = mol \% PEP + mol \% PEE + mol \% EEE$$

$$C 3 [ mol \% ] = mol \% PPP + mol \% PPE + mol \% EPE$$

$$C 4 [ mol \% ] = mol \% XBX$$

The weight percent comonomer is calculated from the mole percent in the usual manner:

$$wt \% C 2 = 100 * ( C 2 [ mol \% ] * 28.06 ) / ( ( C 2 [ mol \% ] * 28.06 ) + ( C 3 [ mol \% ] * 42.08 ) + C 4 [ mol \% ] * 56.11 ) )$$

$$wt \% C 3 = 100 * ( C 3 [ mol \% ] * 42.08 ) / ( ( C 2 [ mol \% ] * 28.06 ) + ( C 3 [ mol \% ] * 42.08 ) + C 4 [ mol \% ] * 56.11 ) )$$

$$wt \% C 4 = 100 * ( C 4 [ mol \% ] * 56.11 ) / ( ( C 2 [ mol \% ] * 28.06 ) + ( C 3 [ mol \% ] * 42.08 ) + C 4 [ mol \% ] * 56.11 ) )$$

The total amount of C2, C3 and C4 is quantified by introducing the calculated values for styrene and vinylene (as butadiene) from 1H NMR:

$$wt \% C 2 total = wt \% C 2 * ( 100 - ( S [ wt \% ] + BD [ wt \% ] ) ) / 100$$

$$wt \% C 3 total = wt \% C 3 * ( 100 - ( S [ wt \% ] + BD [ wt \% ] ) ) / 100$$

$$wt \% C 4 total = wt \% C 4 * ( 100 - ( S [ wt \% ] + BD [ wt \% ] ) ) / 100$$

In case of absence of C4, S or BD the related equation collapses to the only observed structural features.

### d) Differential Scanning Calorimetry (DSC) Analysis, Melting Temperature (Tm) and Crystallization Temperature (Tc):

measured with a TA Instrument Q2000 differential scanning calorimetry (DSC) on 5 to 7 mg samples. DSC is run according to ISO 11357/part 3/method C2 in a heat/cool/heat cycle with a scan rate of 10° C./min in the temperature range of −30° C. to +225° C.

Crystallization temperature and heat of crystallization (Hc) are determined from the cooling step, while melting temperature and heat of fusion (Hf) are determined from the second heating step.

When a sample shows two or more melting temperatures and/or crystallization temperatures only the main melting temperature (at the highest Hc) and main crystallization temperature (at the highest Hf) are displayed in the accordant table. The difference of melting temperature and crystallization temperature (Tm-Tc) is given for the main melting temperature and the main crystallization temperature.

### e) Xylene Cold Solubles (XCS) Content

The quantity of xylene soluble matter in polypropylene is determined according to the ISO16152 (first edition; 2005 Jul. 1).

A weighed amount of a sample is dissolved in hot xylene under reflux conditions at 135° C. The solution is then cooled down under controlled conditions and maintained at 25° C. for 30 minutes to ensure controlled crystallization of the insoluble fraction. This insoluble fraction is then separated by filtration. Xylene is evaporated from the filtrate leaving the soluble fraction as a residue. The percentage of this fraction is determined gravimetrically.

$$\% XS = \frac{{m}_{1} \times {v}_{0}}{{m}_{0} \times {v}_{1}} \times 100$$

where
m₀ is the mass of the sample test portion weighed, in grams
m₁ is the mass of residue, in grams
v₀ is the original volume of solvent taken
v₁ is the volume of the aliquot taken for determination.

### f) Glass Transition Temperature (Tg)

Glass transition temperature Tg was determined by dynamic mechanical analysis (DMTA) according to ISO 6721-7. The measurements were done in torsion mode on compression moulded samples (40×10×1 mm³) between −100° C. and +150° C. with a heating rate of 2° C./min and a frequency of 1 Hz. Tg was determined from the curve of the loss angle (tan (8)).

### g) Intrinsic Viscosity (IV)

The reduced viscosity (also known as viscosity number), η_{red}, and intrinsic viscosity, IV, are determined according to ISO 1628-3: “Determination of the viscosity of polymers in dilute solution using capillary viscometers”.

Relative viscosities of a diluted polymer solution with concentration of 1 mg/ml and of the pure solvent (decahydronaphthalene stabilized with 200 ppm 2,6-bis(1,1-dimethylethyl)-4-methylphenol) are determined in an automated capillary viscometer (Lauda PVS1) equipped with 4 Ubbelohde capillaries placed in a thermostatic bath filled with silicone oil. The bath temperature is maintained at 135° C. The sample is dissolved with constant stirring until complete dissolution is achieved (typically within 90 min).

The efflux time of the polymer solution as well as of the pure solvent are measured several times until three consecutive readings do not differ for more than 0.2 s (standard deviation).

The relative viscosity of the polymer solution is determined as the ratio of averaged efflux times in seconds obtained for both, polymer solution and solvent:

$${η}_{rel} = \frac{{t}_{solution} - {t}_{solvent}}{{t}_{solvent}} [ dimensionless ]$$

Reduced viscosity (η_{red}) is calculated using the equation:

$${η}_{red} = \frac{{t}_{solution} - {t}_{solvent}}{{t}_{solvent} * C} [ dl / g ]$$

where C is the polymer solution concentration at 135° C.:

$$C = \frac{m}{V γ} ,$$

and m is the polymer mass, Vis the solvent volume, and γ is the ratio of solvent densities at 20° C. and 135° C. (γ=ρ₂₀/ρ₁₃₅=1.107).

The calculation of intrinsic viscosity IV is performed by using the Schulz-Blaschke equation from the single concentration measurement:

$$IV = \frac{{η}_{red}}{1 + K + C + {η}_{red}}$$

where K is a coefficient depending on the polymer structure and concentration. For calculation of the approximate value for IV, K=0.27.

### h) Molecular Weight Averages, Polydispersity (Mn, Mw, Mz, MWD) by GPC-Analysis (GPC)

For the GPC analysis the column set was calibrated using universal calibration (according to ISO 16014-2:2003) with 19 narrow MWD polystyrene (PS) standards in the range of 0.5 kg/mol to 11 500 kg/mol. The PS standards were dissolved at 160° C. for 15 min or alternatively at room temperatures at a concentration of 0.2 mg/ml for molecular weight higher and equal 899 kg/mol and at a concentration of 1 mg/ml for molecular weight below 899 kg/mol. The conversion of the polystyrene peak molecular weight to polyethylene molecular weights is accomplished by using the Mark Houwink equation and the following Mark Houwink constants:

$${K}_{PS} = 19 \times {10}^{- 3} ml / g , {α}_{PS} = 0.655$$

$${K}_{PE} = 39 \times {10}^{- 3} ml / g , {α}_{PE} = 0.725$$

A third order polynomial fit was used to fit the calibration data.

Molecular weight averages (Mz, Mw and Mn), Molecular weight distribution (MWD) and its broadness, described by polydispersity index, PDI=Mw/Mn (wherein Mn is the number average molecular weight and Mw is the weight average molecular weight) were determined using the following formulas:

$${M}_{n} = \frac{{\sum }_{i = 1}^{N} {A}_{i}}{\sum ( {A}_{i} / {M}_{i} )} \qquad ( 1 )$$

$${M}_{w} = \frac{{\sum }_{i = 1}^{N} ( {A}_{i} \times {M}_{i} )}{\sum {A}_{i}} \qquad ( 2 )$$

$${M}_{z} = \frac{{\sum }_{i = 1}^{N} ( {A}_{i} \times {M}_{i}^{2} )}{\sum ( {A}_{i} / {M}_{i} )} \qquad ( 3 )$$

### i) Flexural Modulus

The flexural modulus was determined acc. to ISO 178 method A (3-point bending test) on 80 mm×10 mm×4 mm specimens. Following the standard, a test speed of 2 mm/min and a span length of 16 times the thickness was used. The testing temperature was 23±2° C. Injection moulding was carried out according to ISO 19069-2 using a melt temperature of 230° C. for all materials irrespective of material melt flow rate.

### j) Charpy Notched Impact Strength

The Charpy notched impact strength was determined acc. to ISO 179-1/1eA on notched 80 mm×10 mm×4 mm specimens (specimens were prepared according to ISO 179-1/1eA). Testing temperatures were 23±2° C. or −20±2° C. Injection moulding was carried out acc. to ISO 19069-2 using a melt temperature of 230° C. for all materials irrespective of material melt flow rate.

### k) Rheological Measurements

### Dynamic Shear Measurements (Frequency Sweep Measurements)

The characterisation of melt of polymer composition or polymer as given above or below in the context by dynamic shear measurements complies with ISO standards 6721-1 and 6721-10. The measurements were performed on an Anton Paar MCR501 stress controlled rotational rheometer, equipped with a 25 mm parallel plate geometry. Measurements were undertaken on compression moulded plates, using nitrogen atmosphere and setting a strain within the linear viscoelastic regime. The oscillatory shear tests were done at 190° C. applying a frequency range between 0.01 and 600 rad/s and setting a gap of 1.3 mm.

In a dynamic shear experiment the probe is subjected to a homogeneous deformation at a sinusoidal varying shear strain or shear stress (strain and stress controlled mode, respectively). On a controlled strain experiment, the probe is subjected to a sinusoidal strain that can be expressed by

$$γ ( t ) = {γ}_{0} sin ( ω t ) \qquad ( 1 )$$

If the applied strain is within the linear viscoelastic regime, the resulting sinusoidal stress response can be given by

$$σ ( t ) = {σ}_{0} sin ( ω t + δ ) \qquad ( 2 )$$

where
σ₀ and γ₀ are the stress and strain amplitudes, respectively
ω is the angular frequency
δ is the phase shift (loss angle between applied strain and stress response)
t is the time

Dynamic test results are typically expressed by means of several different rheological functions, namely the shear storage modulus G′, the shear loss modulus, G″, the complex shear modulus, G*, the complex shear viscosity, η*, the dynamic shear viscosity, η′, the out-of-phase component of the complex shear viscosity η″ and the loss tangent, tan δ which can be expressed as follows:

$${G}^{′} = \frac{{σ}_{0}}{{γ}_{0}} cos δ [ Pa ] \qquad ( 3 )$$

$${G}^{″} = \frac{{σ}_{0}}{{γ}_{0}} sin δ [ Pa ] \qquad ( 4 )$$

$${G}^{*} = {G}^{′} + {iG}^{″} [ Pa ] \qquad ( 5 )$$

$${η}^{*} = {η}^{′} - i {η}^{″} [ Pa \cdot s ] \qquad ( 6 )$$

$${η}^{′} = \frac{{G}^{″}}{ω} [ Pa \cdot s ] \qquad ( 7 )$$

$${η}^{″} = \frac{{G}^{′}}{ω} [ Pa \cdot s ] \qquad ( 8 )$$

The determination of so-called Shear Thinning Index, which correlates with MWD and is independent of Mw, is done as described in equation 9.

$${SHI}_{( x / y )} = \frac{{Eta}^{*} for ( {G}^{*} = x kPa )}{{Eta}^{*} for ( {G}^{*} = y kPa} \qquad ( 9 )$$

For example, the SHI_{(2/100)} is defined by the value of the complex viscosity, in Pa·s, determined for a value of G* equal to 1 kPa, divided by the value of the complex viscosity, in Pa·s, determined for a value of G* equal to 100 kPa.

The values of storage modulus (G′), loss modulus (G″), complex modulus (G*) and complex viscosity (η*) were obtained as a function of frequency (ω).

Thereby, e.g. η*_{300rad/s} (eta*_{300rad/s} or eta₃₀₀) is used as abbreviation for the complex viscosity at the frequency of 300 rad/s and n*_{0.05rad/s} (eta*_{0.05rad/s} or eta_{0.05}) is used as abbreviation for the complex viscosity at the frequency of 0.05 rad/s.

The polydispersity index, PI, is defined by equation 10.

$$P I = \frac{{10}^{5}}{{G}^{′} ( {ω}_{COP} )} , {ω}_{COP} = ω for ( {G}^{′} = {G}^{″} ) \qquad ( 10 )$$

where ω_{COP} is the cross-over angular frequency, determined as the angular frequency for which the storage modulus, G′, equals the loss modulus, G″.

The values are determined by means of a single point interpolation procedure, as defined by Rheoplus software. In situations for which a given G* value is not experimentally reached, the value is determined by means of an extrapolation, using the same procedure as before. In both cases (interpolation or extrapolation), the option from Rheoplus “Interpolate y-values to x-values from parameter” and the “logarithmic interpolation type” were applied.

### REFERENCES

[1] Rheological characterization of polyethylene fractions” Heino, E. L., Lehtinen, A., Tanner J., Seppälä, J., Neste Oy, Porvoo, Finland, Theor. Appl. Rheol., Proc. Int. Congr. Rheol, 11th (1992), 1, 360-362
[2] The influence of molecular structure on some rheological properties of polyethylene”, Heino, E. L., Borealis Polymers Oy, Porvoo, Finland, Annual Transactions of the Nordic Rheology Society, 1995.).
[3] Definition of terms relating to the non-ultimate mechanical properties of polymers, Pure & Appl. Chem., Vol. 70, No. 3, pp. 701-754, 1998.

### l) AC Electric Breakdown Strength (ACBD)

The AC breakdown tests were performed in agreement with CENELEC HD 605 5.4.15.3.4 for 6/10 kV cables. The cable was thus cut into six test samples of 10 meter active length (terminations in addition). The samples were tested to breakdown with a 50 Hz AC step test at ambient temperature, according to the following procedure:
Start at 18 kV for 5 minutes.
Voltage increasing in step of 6 kV every 5 minutes until breakdown occurs

The calculation of the Weibull parameters of the data set of six breakdown values (conductor stress, i.e. the electric field at the inner semiconductive layer) follows the least squares regression procedure as described in IEC 62539 (2007). The Weibull alpha parameter in this document refers to the scale parameter of the Weibull distribution, i.e. the voltage for which the failure probability is 0.632. The Weibull beta value refers to the shape parameter.

### 2. Propylene Copolymer Composition

The following resins were used for the preparation of the propylene copolymer compositions of the examples:

### a) Polymerization of the Heterophasic Propylene Copolymer Powder A1

### Catalyst

The catalyst used in the polymerization process for the heterophasic propylene copolymer powder A1 was a Ziegler-Natta catalyst, which is described in patent publications EP491566, EP591224 and EP586390. As co-catalyst triethyl-aluminium (TEAL) and as donor dicyclo pentyl dimethoxy silane (D-donor) was used.

### Polymerization of the Heterophasic Propylene Copolymer Powder

Heterophasic propylene copolymer powder A1 was produced in a Borstar™ plant in the presence of the above described polymerization catalyst using one liquid-phase loop reactor and two gas phase reactors connected in series under conditions as shown in Table 1. The first reaction zone was a loop reactor and the second and third reaction zones were gas phase reactors. The matrix phase was polymerized in the loop and first gas phase reactor and the elastomeric phase was polymerized in the 10 second gas phase reactor. The catalyst as described above was fed into a prepolymerization reactor which precedes the first reaction zone.

TABLE 1
Polymerization conditions of the heterophasic
propylene copolymer powder:

| | | A1-powder |
|---|---|---|
| Prepolymerization | | |
| TEAL/Ti ratio | [mol/mol] | 342 |
| Donor/Ti ratio | [mol/mol] | 26.9 |
| Temperature | [° C.] | 19.9 |
| Residence time | [h] | 0.16 |
| Loop | | |
| Temperature | [° C.] | 70.0 |
| Pressure | [barg] | 55 |
| Split (Loop + Prepol) | [%] | 33.7 |
| H2/C3 ratio | [mol/kmol] | 5.5 |
| C2/C3 ratio | [mol/kmol] | 16.7 |
| MFR (230° C./2.16 kg) | [g/10 min] | 6.5 |
| C2 content (calc.) | [wt %] | 2.0 |
| GPR 1 | | |
| Temperature | [° C.] | 74.9 |
| Pressure | [barg] | 21.0 |
| Split (GPR1) | [%] | 48.2 |
| H2/C3 ratio | [mol/kmol] | 21.3 |
| C2/C3 ratio | [mol/kmol] | 53.4 |
| MFR (230° C./2.16 kg) | [g/10 min] | 1.3 |
| C2 content (calc.) | [wt %] | 6.5 |
| GPR 2 | | |
| Temperature | [° C.] | 79.99 |
| Pressure | [barg] | 16.03 |
| Split (GPR2) | [%] | 18.2 |
| C2/C3 ratio | [mol/kmol] | 401 |
| H2/C3 ratio | [mol/kmol] | 69 |
| MFR (230° C./2.16 kg) | [g/10 min] | 1.2 |
| XCS | [wt %] | 35.3 |
| C2 (content calc.) | [wt %] | 10.5 |

### b) Preparation of the Polypropylene Compositions

The heterophasic propylene copolymer powder A1 from the polymerization reaction was compounded in a twin screw extruder together with different stabilizer packages to obtain the polypropylene compositions of reference examples RE1, RE2 and RE3. For reference examples RE1 and RE3 alpha-nucleating agent was added.

The composition of example RE3 was vis-broken to a melt flow rate MFR₂ (230° C., 2.16 kg) of 3.9 g/10 min as disclosed in the example section of WO 2017/198633.

An overview of the production of the polypropylene compositions of examples RE1, RE2 and RE3 are shown in Table 2.

TABLE 2
Compounding of RE1, RE2 and RE3 in a twin screw extruder:

| | | RE1 | RE2 | RE3 |
|---|---|---|---|---|
| HECO-powder | | A1- | A1- | A1- |
| | | powder | powder | powder |
| Visbreaking | | no | no | yes |
| Stabiliser onepack 1 | [wt %] | 0.2 | 0.2 | — |
| Stabiliser Onepack 2 | [wt %] | — | — | 0.14 |
| Alpha-NA BNT | [wt %] | 2.0 | — | 2.0 |
| Temp. ranges of extruder zones | [° C.] | 140-300 | 140-300 | 150-280 |
| Specific Energy Input (SEI) | kWh/kg | 0.157 | 0.155 | 0.146 |
| Polymer melt temp. at melt | [° C.] | 242 | 244 | 231 |
| pump | | | | |

The polypropylene compositions RE1, RE2 and RE3 show the properties as listed below in Table 3.

TABLE 3
Properties of polypropylene compositions RE1, RE2 and RE3:

| | | RE1 | RE2 | RE3 |
|---|---|---|---|---|
| alpha-NA | | BNT | no | BNT |
| MFR₂ | [g/10 min] | 1.3 | 1.2 | 3.9 |
| Flexural modulus | [MPa] | 370 | 335 | 378 |
| Charpy NIS | [kJ/m²] | 6.5 | 6.3 | 4.2 |
| (−20° C.) | | | | |
| Charpy NIS | [kJ/m²] | 83.6 | 83.9 | 78.9 |
| (23° C.) | | | | |
| Tm | [° C.] | 146.6 | 148.9 | 147.4 |
| Tc | [° C.] | 113.6 | 95.7 | 114.5 |
| Tm − Tc | [° C.] | 33.0 | 53.2 | 32.9 |
| C2 (total) | [wt %] | 12.4 | 12.4 | 11.3 |
| IV (total) | [cm³/g] | 268 | 277 | 213 |
| XCS fraction | [wt %] | 34.7 | 35.6 | 35.6 |
| C2 (XCS) | [wt %] | 26.3 | 26.1 | 24.5 |
| IV (XCS) | [cm³/g] | 243 | 251 | 189 |
| Mw (XCS) | [g/mol] | 285,000 | 294,500 | 215,000 |
| Mn (XCS) | [g/mol] | 45,400 | 45,650 | 48,900 |
| PDI (Mw/Mn) | [—] | 6.3 | 6.4 | 4.4 |
| (XCS) | | | | |
| XCI fraction | [wt %] | 65.3 | 64.4 | 64.4 |
| C2 (XCI) | [wt %] | 5.5 | 4.8 | 5.8 |
| IV (XCI) | [cm³/g] | 275 | 286 | 216 |
| Mw (XCI) | [g/mol] | 372,500 | 384,500 | 271,000 |
| Mn (XCI) | [g/mol] | 68,100 | 69,500 | 62,000 |
| PDI (Mw/Mn) | [—] | 5.5 | 5.5 | 4.4 |
| (XCI) | | | | |
| IV ratio | [—] | 1.13 | 1.14 | 1.14 |
| (XCI/XCS) | | | | |
| Mw ratio | [—] | 1.31 | 1.31 | 1.26 |
| (XCI/XCS) | | | | |

For the production of the polymer compositions of the inventive examples IE1 and IE2 and comparative example CE1 the compounded pellets of reference example RE2 were compounded in a second compounding step in a Buss 100 MDK L/D 11D co-kneader together with different additives. Further the compounded pellets of reference example RE1 were compounded in a second compounding step in a Buss 100 MDK L/D 11D co-kneader together with different additives to obtain the polypropylene composition of example IE3 and comparative example CE2.

An overview of the production of the polypropylene compositions CE1, IE1, IE2, CE2 and IE3 are shown in Table 4. The properties of CE1, IE1, IE2, CE2 and IE3 are shown in Table 6.

TABLE 4
Compounding of IE1-IE3, CE1 and CE2
in a Buss 100 MDK L/D 11D co-kneader:

| | | CE1 | IE1 | IE2 | CE2 | IE3 |
|---|---|---|---|---|---|---|
| Pellets | | RE2 | RE2 | RE2 | RE1 | RE1 |
| SEBS-1 | [wt %] | — | 10 | — | — | — |
| SEBS-2 | [wt %] | — | — | 10 | — | — |
| SEPS | [wt %] | — | — | — | — | 10 |
| Mixer zones temperatures | [° C.] | | 117-211 | 119-213 | 132-210 | 128-211 |
| Mixer RPM | | | 146 | 146 | 150 | 150 |
| Specific Energy Input SEI | [kWh/kg] | | 0.28 | 0.31 | 0.29 | 0.24 |

Stabilizer packages and additives:
Stabiliser onepack 1 consists of 21.8 wt % Pentaerythrityl-tetrakis(3-(3′,5′-di-tert. butyl-4-hydroxyphenyl)-propionate (CAS-No. 6683-19-8), 43.6 wt % Tris (2,4-di-t-butylphenyl) phosphite (CAS-No. 31570-04-4) and 34.6 wt % Calcium stearate (CAS-No. 1592-23-0), all commercially available from a variety of companies.
Stabiliser onepack 2 consists of 29 wt % Pentaerythrityl-tetrakis(3-(3′,5′-di-tert. butyl-4-hydroxyphenyl)-propionate (CAS-No. 6683-19-8), 58 wt % Tris (2,4-di-t-butylphenyl) phosphite (CAS-No. 31570-04-4) and 13 wt % Magnesium Oxide (CAS-No. 1309-48-4), all commercially available from a variety of companies.
Alpha-nucleation via BNT was achieved by adding 2 wt % of a propylene homopolymer with an MFR₂ (230° C.) of 8.0 g/10 min and a melting temperature of 162° C., which is produced with a Ziegler-Natta type catalyst in the Borealis nucleation technology (BNT), comprising a polymeric α-nucleating agent, and is distributed by Borealis AG (Austria).
SEPS is a styrene ethylene propylene styrene block copolymer with polystyrene content of 18.5-22.5 wt %, a styrene to ethylene-propylene (S/EP) weight ratio of 21/79, a melt flow rate MFR₅ of 13 g/10 min (ASTM D 1238, 230° C., 5 kg), a shore A hardness of 61 (ASTM D 2240) and a density of 0.90 g/cm³ (ASTM D 792), commercially available as Kraton G 1730 M from Kraton Polymers. Properties disclosed in technical data sheet.
SEBS-1 and SEBS-2 are styrene-ethylene-butylene-styrene block copolymers having the properties as measured in Table 5.

TABLE 5
Properties of SEBS-1 and SEBS-2

| | | SEBS-1 | SEBS-2 |
|---|---|---|---|
| Density | [kg/m³] | 879.8 | 876.2 |
| MFR₂ | [g/10 min] | 6.5 | 3.1 |
| Tm | [° C.] | 83.8 | 65.2 |
| Tc | [° C.] | 49.4 | 11.5 |
| Tm − Tc | [° C.] | 34.4 | 53.7 |
| Tg | [° C.] | −36.1 | −43.9 |
| C2 (total) | [wt %] | 94.7 | 93.4 |
| S (total) | [wt %] | 4.5 | 4.8 |
| BD (total) | [wt %] | 0.9 | 1.7 |
| ω_{COP} | [1/s] | 115.6 | 62.9 |
| SHI 1/100 | [—] | 5.06 | 2.29 |
| PI | [1/s] | 0.96 | 0.88 |

For the SEBS-1 and SEBS-2 components and the polypropylene compositions CE1, IE1, IE2, CE2 and IE3 the total contents of styrene, ethylene (C2), 1-butene (C4) and propylene (C3) as well as the contents of styrene, ethylene (C2), 1-butene (C4) and propylene (C3) in the XCS and XCI fractions has been measured by ¹H NMR measurement for the quantification of styrene and vinylene and ¹³C NMR measurement for the quantification of C2, C3 and C4 as described above. The contents of styrene, ethylene (C2), 1-butene (C4) and propylene (C3) are shown in Table 6 together with other properties of CE1, IE1, IE2, CE2 and IE3.

TABLE 6
Properties of the compounded compositions of CE1, IE1, IE2, CE2 and IE3

| | | CE1 | IE1 | IE2 | CE2 | IE3 |
|---|---|---|---|---|---|---|
| MFR₂ | [g/10 min] | 1.3 | 1.7 | 1.5 | 1.3 | 1.6 |
| Flex. modulus | [MPa] | 352 | 222 | 264 | 370 | 298 |
| Charpy NIS 23° C. | [kg/m³] | 75.9 | 75.4 | 75.0 | 83.6 | 82.6 |
| Charpy NIS −20° C. | [kg/m²] | 5.9 | 11.7 | 52.4 (6 PB) | 6.5 | 68.4 (6 PB) |
| | | | | 12.6 (4 CB) | | 10.4 (4 CB) |
| Tm | [° C.] | 149.7 | 149.9 | 149.9 | 146.6 | 147.0 |
| Tc | [° C.] | 97.5 | 95.7 | 96.4 | 113.6 | 113.1 |
| Tm − Tc | [° C.] | 52.2 | 54.4 | 53.5 | 33.0 | 33.9 |
| Tg (EP) | [° C.] | −47.4 | −40.1 | −47.5 | −47.5 | −46.8 |
| Tg (Matrix) | [° C.] | −8.6 | −9.4 | −8.3 | −7.1 | −5.3 |
| C2 (total) | [wt %] | 12.4 | 15.4 | 14.8 | 12.4 | 14.2 |
| C3 (total) | [wt %] | n.a. | 78.5 | 78.7 | 87.6 | 83.8 |
| C4 (total) | [wt %] | n.a. | 5.5 | 5.9 | n.a. | n.a. |
| S (total) | [wt %] | n.a. | 0.5 | 0.4 | n.a. | 2.0 |
| BD (total) | [wt %] | n.a. | 0.2 | 0.1 | n.a. | n.a. |
| XCS fraction | [wt %] | 35.8 | 40.9 | 43.0 | 34.7 | 41.1 |
| C2 (XCS) | [wt %] | 25.6 | 30.1 | 28.5 | 26.3 | 28.1 |
| C3 (XCS) | [wt %] | n.a. | 55.9 | 57.0 | 73.7 | 67.0 |
| C4 (XCS) | [wt %] | n.a. | 12.4 | 13.3 | n.a. | n.a. |
| S (XCS) | [wt %] | n.a. | 1.1 | 1.0 | n.a. | 4.9 |
| BD (XCS) | [wt %] | n.a. | 0.4 | 0.2 | n.a. | n.a. |
| IV (XCS) | [cm³/g] | 247 | 220 | 226 | 243 | 204 |
| Mw (XCS) | [g/mol] | 260,500 | 230,000 | 226,000 | 285,000 | 221,500 |
| Mn (XCS) | [g/mol] | 40,750 | 45,750 | 44,650 | 45,400 | 50,300 |
| Mw/Mn (XCS) | [—] | 6.4 | 5.1 | 5.1 | 6.3 | 4.4 |
| XCI fraction | [wt %] | 64.2 | 59.1 | 57.0 | 65.3 | 59.0 |
| C2 (XCI) | [wt %] | 5.2 | 6.0 | 5.6 | 5.5 | 5.8 |
| C3 (XCI) | [wt %] | n.a. | 94.0 | 93.2 | 94.5 | 94.1 |
| C4 (XCI) | [wt %] | n.a. | <0.5 | 1.2 | n.a. | n.a. |
| S (XCI) | [wt %] | n.a. | <0.05 | <0.05 | n.a. | 0.1 |
| BD (XCI) | [wt %] | n.a. | <0.05 | <0.05 | n.a. | n.a. |
| IV (XCI) | [cm³/g] | 278 | 279 | 293 | 275 | 271 |
| Mw (XCI) | [g/mol] | 329,500 | 339,000 | 326,000 | 372,500 | 342,500 |
| Mn (XCI) | [g/mol] | 59,350 | 59,000 | 57,100 | 68,100 | 71,200 |
| Mw/Mn (XCI) | [—] | 5.6 | 5.8 | 5.7 | 5.5 | 4.8 |
| IV(XCI)/IV(XCS) | [—] | 1.13 | 1.27 | 1.30 | 1.13 | 1.33 |
| Mw(XCI)/Mw(XCS) | [—] | 1.26 | 1.47 | 1.44 | 1.31 | 1.55 |
| ω_{COP} | [1/s] | 14.0 | 19.3 | 17.6 | 14.4 | 19.0 |
| SHI 1/100 | [—] | 10.8 | 9.9 | 9.1 | 10.9 | 10.2 |
| PI | [1/s] | 2.7 | 2.4 | 2.3 | 2.7 | 2.3 |

n.a. not applicable
PB = partial break,
CB = complete break

It can be seen that the inventive compositions IE1 to IE3 show higher flexibility and impact properties in addition to comparable crystallization and melting temperature compared to the comparative compositions CE1 and CE2. Thereby, during the measurement of the Charpy impact strength at −20° C. the 10 measured samples of IE2 and IE3 showed borderline behavior of partial breaks and complete breaks. In the table above the average value for partial breaks (PB) and complete breaks (CB) are listed as required in ISO 179-1.

### 3. Production of 10 kV Cables

10 kV test cables were produced on a Maillefer pilot cable line of catenary continuous vulcanizing (CCV) type.

The conductors of the cable cores had a cross section being 50 mm² of stranded aluminium and had a cross section of 50 mm². The inner semiconductive layer was produced from either semiconductive composition SC2 or SC3 as described below and had a thickness of 1.0 mm. The insulation layer was produced from the above described compositions CE1 and CE2, and IE1 to IE3, and had a thickness of 3.4 mm. The outer semiconductive layer was produced from semiconductive compositions SC1 as described below and had a thickness of 1.0 mm.

The cables, i.e. cable cores, were produced by extrusion via a triple head. The insulation extruder had size 100 mm, the extruder for conductor screen (inner semiconductive layer) 45 mm, and the extruder for insulation screen (outer semiconductive layer) 60 mm. The line speed was 6.0 m/min.

The vulcanisation tube had a total length of 52.5 meter consisting of a curing section followed by a cooling section. The curing section was filled with N₂ at 10 bar but not heated. The 33-meter-long cooling section was filled with 20-25° C. water.

The pilot cables were then subjected to AC breakdown testing.

Semiconductive layer 1 (SC1) was prepared from ready-to-use semiconductive composition Borlink LE7710, which is a non-crosslinkable polyethylene based composition comprising carbon black, commercially available from Borealis AG.

Semiconductive layer 2 (SC2) was prepared from 66.5 wt % of the polypropylene based composition of RE3 with 33.0 wt % of carbon black Printex Alpha, commercially available from Orion Engineered Carbons GmbH and 0.5 maleic anhydride functionalized polypropylene Exxelor PO1020, commercially available from Exxon Mobil.

Semiconductive layer 3 (SC3) was prepared from 66.5 wt % of the polypropylene based composition of RE1 with 33.0 wt % of carbon black Printex Alpha, commercially available from Orion Engineered Carbons GmbH, and 0.5 wt % maleic anhydride functionalized polypropylene Exxelor PO1020, commercially available from Exxon Mobil.

Table 7 shows the electric properties of the 10 kV cables of examples C1-C5 in which the inventive insulation layers IE1-IE3 are compared to comparative insulation layers CE1 and CE2.

TABLE 7
Electric properties of 10 kV cables of C1-C5

| | C1 | C2 | C3 | C4 | C5 |
|---|---|---|---|---|---|
| Insulation layer | CE1 | IE1 | IE2 | CE2 | IE3 |
| Inner semiconductive layer | SC2 | SC2 | SC2 | SC3 | SC3 |
| Outer semiconductive layer | SC1 | SC1 | SC1 | SC1 | SC1 |
| Weibull-alpha (scale) [kV/mm] | 42.3 | 46.7 | 51.7 | 48.7 | 50.8 |
| Weibull-beta (shape) | 14.3 | 18.3 | 11.4 | 11.0 | 6.9 |

It can be seen that the cables comprising the inventive insulation layers IE1, IE2 and IE3 all show an increased Weibull-alpha value compared to the cables comprising the accordant comparative insulation layer CE1 and CE2. Cable C2 comprising the inventive insulation layer IE1 even shows an increased Weibull-beta value compared to the cable C1 comprising comparative insulation layer CE1.

1. A cable comprising at least one layer comprising a polypropylene composition comprising:
(A) from 80.0 to 99.0 wt.-%, based on the total weight of the polypropylene composition, of a copolymer of propylene and comonomer units selected from ethylene and alpha-olefins having from 4 to 12 carbon atoms having
a total amount of comonomer units of from 10.0 to 16.0 wt %, based on the total amount of monomer units of the copolymer of propylene (A), determined by quantitative ¹³C{¹H} NMR measurement;
a melt flow rate MFR₂ of from 0.5 to 5.0 g/10 min, determined according to ISO 1133 at 230° C. and 2.16 kg;
a xylene cold soluble (XCS) fraction in a total amount of from 25.0 to 50.0 wt %, based on the total weight amount of the copolymer of propylene (A) and determined according to ISO16152; and
(B) from 1.0 to 20.0 wt.-%, based on the total weight of the polypropylene composition, of linear styrene block copolymer with a middle block containing sequences of ethylene, propylene and/or 1-butene, having a total content of styrene units of from 1.0 to 30.0 wt.-%, based on the total weight amount of the linear block copolymer (B), measurable using quantitative ¹³C{¹H} NMR measurement.

2. The cable according to claim 1, wherein the copolymer of propylene (A) is a heterophasic copolymer of propylene which comprises a matrix phase and an elastomeric phase dispersed in said matrix phase, which preferably comprises two glass transition temperatures attributed to the matrix phase and the elastomeric phase, wherein the glass transition temperature attributed to the matrix phase Tg (matrix) is in the range of from −1.0 to ˜15.0° C. and/or the glass transition temperature attributed to the elastomeric phase Tg (EP) is in the range of from −40.0 to −55.0° C., wherein Tg (matrix) and Tg (EP) are determined by dynamic mechanical analysis.

3. The cable according to claim 1, wherein xylene cold soluble (XCS) fraction of the copolymer of propylene (A) has an amount of comonomer units, preferably of ethylene, of from 23.0 to 35.0 wt %, based on the total amount of monomer units in the xylene cold soluble (XCS) fraction and determined by quantitative ¹³C{¹H} NMR measurement, and/or an intrinsic viscosity of from 150 to 350 cm³/g, measured in decalin according to ISO 1628-3.

4. The cable according to claim 1, wherein the copolymer of propylene (A) has a fraction insoluble in cold xylene (XCI) in a total amount of from 50.0 to 75.0 wt %, based on the total weight amount of the copolymer of propylene (A) and determined according to ISO16152, and wherein the fraction insoluble in cold xylene (XCI) preferably has an amount of comonomer units, preferably of ethylene, of from 3.0 to 9.0 wt %, based on the total amount of monomer units in the fraction insoluble in cold xylene (XCI) and determined by quantitative ¹³C{¹H} NMR measurement, and/or an intrinsic viscosity of preferably from 185 to 350 cm³/g, measured in decalin according to ISO 1628-3.

5. The cable according to claim 1, wherein the copolymer of propylene (A) has one or more of the following properties:
a flexural modulus of from 130 MPa to 400 MPa, determined according to ISO 178 method A; and/or
a Charpy notched impact strength at 23° C. of from 50 to 110 kJ/m², determined according to to ISO 179-1/1eA; and/or
a Charpy notched impact strength at −20° C. of from 5.0 to 10.0 kJ/m², determined according to to ISO 179-1/1eA.

6. The cable according to claim 1, wherein the linear block copolymer (B) is a styrene-ethylene-1-butene-styrene triblock copolymer (SEBS) or a styrene-ethylene-propylene-styrene triblock copolymer (SEPS).

7. The cable according to claim 1, wherein the linear block copolymer (B) is a styrene-ethylene-1-butene-styrene triblock copolymer (SEBS) having one or more of the following properties:
an amount of units derived from ethylene of from 85.0 to 98.9 wt %, based on the total amount of monomer units in the styrene-ethylene-1-butene-styrene triblock copolymer (SEBS), measured by quantitative ¹³C{¹H} NMR measurement; and/or
an amount of units derived from styrene of from 1.0 to 10.0 wt %, based on the total amount of monomer units in the styrene-ethylene-1-butene-styrene triblock copolymer (SEBS), measured by quantitative ¹³C{¹H} NMR measurement; and/or
an amount of units derived from butadiene of from 0.1 to 5.0 wt %, based on the total amount of monomer units in the styrene-ethylene-1-butene-styrene triblock copolymer (SEBS), measured by quantitative ¹³C{¹H} NMR measurement; and/or
a melt flow rate MFR₂ of 1.0 to 10.0 g/10 min, determined by ISO 1133 at a 230° C. and 2.16 kg; and/or
a melting temperature Tm of from 50 to 100° C., determined by differential scanning calorimetry; and/or
a crystallization temperature Tc of from 5 to 50° C., determined by differential scanning calorimetry; and/or
a difference of the melting temperature to the crystallization temperature Tm-Tc is preferably in the range of from 20 to 65° C.;
a glass temperature of from −30 to −50° C., determined by dynamic mechanical analysis;
a shear thinning index SHI_{1/100} of from 1.0 to 7.5, determined by dynamic shear measurements;
a polydispersity index PI of from 0.2 to 1.5 s⁻¹; and/or
a density of from 880 to 915 kg/m³, determined according to ASTM D 792.

8. The cable according to claim 1, wherein the linear block copolymer (B) is a styrene-ethylene-propylene-styrene triblock copolymer (SEPS) having one or more of the following properties:
a total content of styrene units of from 10.0 to 30.0 wt.-%, based on the total weight amount of the linear block copolymer (B), measurable using quantitative ¹³C{¹H} NMR measurement; and/or
a styrene to ethylene/propylene (S/EP) weight ratio of from 10.0:9.0 to 30.0:70.0, measurable using quantitative ¹³C{¹H} NMR measurement; and/or
a melt flow rate MFR₅ of from 1.0 to 25.0 g/10 min, measureable according to ASTM D 1238 at 230° C. and 5 kg; and/or
a density of from 880 to 915 kg/m³, measurable according to ASTM D 792; and/or
a shore A hardness of from 40 to 75, measurable according to ASTM D 2240.

9. The cable according to claim 1, wherein the polypropylene composition has
a total amount of units derived from propylene of from 70.0 to 90.0 wt %;
a total amount of units derived from ethylene of from 7.5 to 25.0 wt %;
a total amount of units derived from 1-butene of from 0 to 12.5 wt %;
a total amount of units derived from butadiene of from 0 to 0.50 wt %; and
a total amount of units derived from styrene of from 0.1 to 10.0 wt %,
all based on the total molar amount monomer units of the polypropylene composition and determined using quantitative ¹³C{¹H} NMR measurement.

10. The cable according to claim 1, wherein the polypropylene composition has a xylene cold soluble (XCS) fraction, which has
a total amount of units derived from propylene of from 47.5 to 75.0 wt %;
a total amount of units derived from ethylene of from 20.0 to 40.0 wt %;
a total amount of units derived from 1-butene of from 0 to 20.0 wt %;
a total amount of units derived from butadiene of from 0 to 1.00 wt %; and
a total amount of units derived from styrene of from 0.3 to 15.0 wt %,
all based on the total molar amount monomer units of the xylene cold soluble (XCS) fraction and determined using quantitative ¹³C{¹H} NMR measurement; and/or
a fraction insoluble in cold xylene (XCI), which has
a total amount of units derived from propylene of from 85.0 to 99.0 wt %;
a total amount of units derived from ethylene of from 0.7 to 10.0 wt %;
a total amount of units derived from 1-butene of from 0 to 2.5 wt %;
a total amount of units derived from butadiene of from 0 to 0.20 wt %; and
a total amount of units derived from styrene of from 0 to 1.00 wt %,
all based on the total molar amount monomer units of the having fraction insoluble in cold xylene (XCI) and determined using quantitative ¹³C{¹H} NMR measurement.

11. The cable according to claim 1, wherein the polypropylene composition has one or more or all of the following properties:
a melt flow rate MFR₂ of 0.5 to 2.5 g/10 min, determined according to ISO 1133 at 230° C. and 2.16 kg; and/or
a melting temperature Tm of from 140 to 159° C., determined by differential scanning calorimetry; and/or
a crystallization temperature Tc of from 85 to 130° C., determined by differential scanning calorimetry; and/or
a difference of the melting temperature to the crystallization temperature Tm-Tc is preferably in the range of from 20 to 65° C.; and/or
a glass temperature attributed to the matrix phase Tg (matrix) in the range of from −1.0 to −15.0° C., determined by dynamic mechanical analysis; and/or
a glass temperature attributed to the elastomeric phase Tg (EP) of from −35.0 to −55.0° C., determined by dynamic mechanical analysis; and/or
shear thinning index SHI_{1/100} of from 2.5 to 20.0, determined by dynamic shear measurements; and/or
a polydispersity index PI of from 1.0 to 4.0 s⁻¹, determined by dynamic shear measurements.

12. The cable according to claim 1, wherein the polypropylene composition has one or more or all of the following properties:
a flexural modulus of from 130 MPa to 350 MPa, determined according to ISO 178 method A; and/or
a Charpy notched impact strength at 23° C. of from 50 to 110 kJ/m², determined according to to ISO 179-1/1eA; and/or
a Charpy notched impact strength at −20° C. of from 7.5 to 80.0 kJ/m², determined according to to ISO 179-1/1eA.

13. The cable according to claim 1, wherein the polypropylene composition is free of a dielectric fluid.

14. The cable according to claim 1 being a medium voltage cable or high voltage cable, comprising an insulation layer comprising the polypropylene composition.

15. The cable according to claim 14 having a Weibull alpha-value of from 35.0 to 65.0 kV/mm and/or a Weibull beta-value of from 5.0 to 250.0, measured on a 10 kV cable in agreement with CENELEC HD 605 5.4.15.3.4 for 6/10 kV cables.
